(19) United States
(12) Patent Application Publication
(10) Pub. No.: US 2026/0163365 A1
(43) Pub. Date: Jun. 11, 2026

(54) SYSTEM AND METHOD FOR DISENGAGING CIRCUIT COMPONENTS FROM AN ENERGY STORAGE DEVICE

(71) Applicant: Senseonics, Incorporated, Germantown, MD (US)

(72) Inventors: James Masciotti, Germantown, MD (US); Abhi Chavan, Germantown, MD (US)

(73) Assignee: Senseonics, Incorporated, Germantown, MD (US)

(21) Appl. No.: 19/378,887

(22) Filed: Nov. 4, 2025

Related U.S. Application Data
(60) Provisional application No. 63/730,049, filed on Dec. 10, 2024.

(51) Int. Cl. H02J 1/08; H01Q 1/22; H02J 50/20

(52) U.S. Cl. CPC H02J 1/084; H01Q 1/22; H02J 50/20

(57) ABSTRACT

An apparatus (e.g., an analyte sensor) may include an energy storage device, first circuit components, second circuit components, an antenna, a rectifier, and a power switch. The antenna may be configured to generate an alternating current when in an electromagnetic field. The rectifier may be configured to convert the alternating current to direct current. The power switch may be configured to disconnect the energy storage device from the first and second circuit components such that current cannot leak from the energy storage device to the first and second circuit components. The power switch may further be configured to connect the rectifier to the first circuit components in an energy storage device disabled state and connect the energy storage device to at least the second circuit components in an energy storage device enabled state.

### CROSS-REFERENCE TO RELATED APPLICATION

The present application claims the benefit of priority to U.S. Provisional Application Ser. No. 63/730,049, filed on Dec. 10, 2024, which is incorporated herein by reference in its entirety.

### BACKGROUND

### Field of Invention

The present disclosure relates to a power control system and method, and more specifically, a power switch configured to disengage circuit components from an energy storage device and methods of using the same. Aspects of the present disclosure relate to an apparatus (e.g., a wireless, implantable apparatus), which may include the energy storage device, the circuit components, and the power switch configured to disconnect the energy storage device from the circuit components such that current cannot leak from the energy storage device to the circuit components in an energy storage disabled state.

### Discussion of the Background

An apparatus (e.g., an analyte sensor of an analyte monitoring system, a pacemaker, or a stimulator) may include an energy storage device (ESD), such as a battery, fuel cell, capacitor, or supercapacitor, which may provide power to one or more circuit components of the apparatus during operation. However, while in storage, leakage of current from the ESD to the circuit components can shorten the life of the apparatus. Additionally, some apparatuses also include an antenna that can receive power wirelessly from an external device, receive data, and/or convey data. However, the overall communication range can be limited if the ESD is simultaneously being used to supply power to circuit components of the apparatus and convey or receive data.

### SUMMARY

In some aspects, when a primary energy storage device (e.g., a battery, fuel cell, supercapacitor, or other power source) of an apparatus is connected to a secondary energy storage device (e.g., a capacitor such as a ceramic capacitor or a supercapacitor) and/or circuit components of the apparatus, some amount of leakage current (e.g., 2-10 nA) may constantly flow through the secondary energy storage device and circuit components. This leakage current may reduce the shelf life of the apparatus. Some aspects of the invention may overcome this deficiency by including a power switch that disconnects the primary energy storage device from the secondary energy storage device and/or circuit components (e.g., while the apparatus is kept in storage and/or shipped). In some aspects, the power switch may keep only a control block that maintains the on/off state powered at all times, which may result in very little current consumption (e.g., ˜1 nA) while the primary energy storage device is disconnected from the capacitor and/or circuit components. In some aspects, this current consumption may have a negligible effect on the shelf life of the apparatus. In some aspects, the apparatus may be configured to, in response to wirelessly receiving an enable energy storage device command, cause the power switch to connect circuit components to the primary energy storage device.

In some aspects, the power switch may additionally or alternatively use a radio frequency (RF) field to power circuit components in order to improve a near field communication (NFC) communication range. In some aspects, the power switch may additionally or alternatively have a capability to power the circuit components via the primary energy storage device while performing NFC communication with an external reader. In some aspects, doing so may reduce the effective load presented to an antenna (e.g., NFC coil) of the apparatus and, as a result, may extend the communication range with the external reader.

One aspect of the invention may provide an apparatus including an energy storage device, first circuit components, second circuit components, an antenna, a rectifier, and a power switch. The antenna may be configured to generate an alternating current when in an electromagnetic field. The rectifier may be configured to convert the alternating current to direct current. The power switch may be configured to disconnect the energy storage device from the first and second circuit components such that current cannot leak from the energy storage device to the first and second circuit components. The power switch may further be configured to connect the rectifier to the first circuit components in an energy storage device disabled state and connect the energy storage device to at least the second circuit components in an energy storage device enabled state. In some aspects, the second circuit components may include a clock and a scheduler.

In some aspects, the power switch may be configured to enter the energy storage device disabled state if a first control signal is in a disable energy storage device state and a second control signal is in a rectifier power state, and the power switch is configured to enter the energy storage device enabled state if the first control signal is in an enable energy storage device state. In some aspects, the power switch may be further configured to connect the energy storage device to the first circuit components and disconnect the rectifier from the first circuit components and the energy storage device if the first control signal is in the enable energy storage device state and the second control signal is in an energy storage device power state, and the power switch may be configured to connect the rectifier to the first circuit components and disconnect the energy storage device from the first circuit components and the rectifier if the first control signal is in the enable energy storage device state and the second control signal is in the rectifier power state.

In some aspects, the second circuit components may include a clock and a scheduler configured to count cycles of the clock and periodically set the second control signal from the rectifier power state to the energy storage device power state. In some aspects, the first circuit components include a measurement controller and measurement electronics, and the measurement controller may be configured to cause the measurement electronics to perform a measurement sequence.

In some aspects, the first circuit components may include a command decoder configured to decode commands in data extracted from the alternating current generated by the antenna. In some aspects, the command decoder may be configured to set the first control signal to the disable energy storage device state if the command decoder decodes a disable energy storage device command and to set the first control signal to the enable energy storage device state if the command decoder decodes an enable energy storage device command.

In some aspects, the power switch may be further configured to connect the energy storage device to the first circuit components and disconnect the rectifier from the first circuit components and the energy storage device if the first control signal is in the enable energy storage device state and a third control signal is in an energy storage device power state, and the power switch may be configured to connect the rectifier to the first circuit components and disconnect the energy storage device from the first circuit components and the rectifier if the first control signal is in the enable energy storage device state and the third control signal is in a rectifier power state.

In some aspects, the power switch may include a first switch, and the power switch may be configured to connect the rectifier to the first circuit components when the first switch is closed and disconnect the rectifier from the energy storage device and the first circuit components when the first switch is open.

In some aspects, the power switch may further include a second switch. The power switch may further be configured to connect the energy storage device to the first circuit components when the second switch is closed and disconnect the energy storage device from the rectifier and the first circuit components when the second switch is open.

In some aspects, the energy storage device may be a primary energy storage device, and the apparatus may further include a secondary energy storage device. In some aspects, the primary energy storage device may have greater energy storage capacity than the secondary energy storage device, and the secondary energy storage device may have greater power delivery than the primary energy storage device. A first terminal of the primary energy storage device may be connected to a first terminal of the secondary energy storage device. The power switch may be further configured to disconnect a second terminal of the primary energy storage device from a second terminal of the secondary energy storage device such that current cannot leak from the primary energy storage device across the secondary energy storage device if the power switch is in the primary energy storage device disabled state. The power switch may be configured to connect the second terminal of the primary energy storage device to the second terminal of the secondary energy storage device such that the secondary energy storage device adds to the power delivery capability of the primary energy storage device if the power switch is in the energy storage device enabled state. In some aspects, the power switch may include third switches. The power switch may be configured to connect the first terminal of the primary energy storage device to the second circuit components and connect the second terminal of the primary energy storage device to the second terminal of the secondary energy storage device by closing the third switches and disconnect the first terminal of the primary energy storage device from the second circuit components and disconnect the second terminal of the primary energy storage device from the second terminal of the secondary energy storage device by opening the third switches. In some aspects, the primary energy storage device may be a battery, fuel cell, or supercapacitor, and the secondary energy storage device may be a capacitor.

In some aspects, the power switch may further include a fourth switch. The power switch may be configured to prevent the energy storage device from supplying power to the second circuit components when the fourth switch is closed. In some aspects, the power switch may be further configured to be reset during a transition from the energy storage device disabled state to the energy storage device enabled state and during a transition from the energy storage device enabled state to the energy storage device disabled. In some aspects, the power switch may be further configured to be reset if a reset control signal is in a reset state.

Another aspect of the invention may provide a method. The method may include using an antenna of an apparatus to generate an alternating current when in an electromagnetic field. The method may include using a rectifier of the apparatus to convert the alternating current to direct current. The method may include using a power switch of the apparatus to disconnect an energy storage device of the apparatus from first and second circuit components of the apparatus such that current cannot leak from the energy storage device to the first and second circuit components and connect the rectifier to the first circuit components in an energy storage device disabled state. The method may include using the power switch to connect the energy storage device to at least the second circuit components in an energy storage device enabled state.

In some aspects, the second circuit components may include a clock and a scheduler. In some aspects, the method may include entering the energy storage device disabled state if a first control signal is in a disable energy storage device state and a second control signal is in a rectifier power state, and the method may include entering the energy storage device enabled state if the first control signal is in an enable energy storage device state.

In some aspects, the method may include using the power switch to connect the energy storage device to the first circuit components and disconnect the rectifier from the first circuit components and the energy storage device if the first control signal is in the enable energy storage device state and the second control signal is in an energy storage device power state. In some aspects, the method may include using the power switch to connect the rectifier to the first circuit components and disconnect the energy storage device from the first circuit components and the rectifier if the first control signal is in the enable energy storage device state and the second control signal is in the rectifier power state. In some aspects, the second circuit components may include a clock and a scheduler and, and the method may include using the scheduler to count cycles of the clock and periodically set the second control signal from the rectifier power state to the energy storage device power state.

In some aspects, the first circuit may include a measurement controller and measurement electronics, and the method may include using the measurement controller to cause the measurement electronics to perform a measurement sequence. In some aspects, the power switch may include a first switch. In some aspects, using the power switch to connect the rectifier to the first circuit components may include closing the first switch. In some aspects, using the power switch to disconnect the rectifier from the energy storage device and the first circuit components may include opening the first switch.

In some aspects, the power switch may include a second switch, using the power switch to connect the energy storage device to the first circuit components may include closing the second switch, and using the power switch to disconnect the energy storage device from the rectifier and the first circuit components may include opening the second switch.

In some aspects, the first circuit components may include a command decoder, and the method may include using the command decoder to decode commands in data extracted from the alternating current generated by the antenna. In some aspects, the command decoder may be configured to set the first control signal to the disable energy storage device state if the command decoder decodes a disable energy storage device command and to set the first control signal to the enable energy storage device state if the command decoder decodes an enable energy storage device command.

In some aspects, the method may include using the power switch to connect the energy storage device to the first circuit components and disconnect the rectifier from the first circuit components and the energy storage device if the first control signal is in the enable energy storage device state and a third control signal is in an energy storage device power state. In some aspects, the method may include using the power switch to connect the rectifier to the first circuit components and disconnect the energy storage device from the first circuit components and the rectifier if the first control signal is in the enable energy storage device state and the third control signal is in a rectifier power state.

In some aspects, the energy storage device may be a primary energy storage device, and a first terminal of the charge storage device may be connected to a first terminal of a secondary energy storage device of the apparatus. In some aspects, the primary energy storage device may have greater energy storage capacity than the secondary energy storage device, and the secondary energy storage device may have greater power delivery than the primary energy storage device. In some aspects, the method may include using the power switch to disconnect a second terminal of the primary energy storage device from a second terminal of the secondary energy storage device such that current cannot leak across the secondary energy storage device if the power switch is in the energy storage device disabled state. In some aspects, the method may include using the power switch to connect the second terminal of the primary energy storage device to the second terminal of the secondary energy storage device such that the secondary energy storage device adds to the power delivery capability of the primary energy storage device if the power switch is in the energy storage device enabled state.

In some aspects, the power switch may include third switches, using the power switch to connect the primary energy storage device to at least the second circuit components may include closing the third switches to connect the first terminal of the primary energy storage device to the second circuit components and connect the second terminal of the primary energy storage device to the second terminal of the secondary energy storage device, and using the power switch to disconnect the primary energy storage device from the second circuit components may include opening the third switches to disconnect the first terminal of the primary energy storage device from the second circuit components and disconnect the second terminal of the primary energy storage device from the second terminal of the secondary energy storage device.

In some aspects, the power switch may include a fourth switch, and using the power switch to disconnect the energy storage device from the second circuit components may include closing the fourth switch. In some aspects, the method may include resetting the power switch during a transition from the energy storage device disabled state to the energy storage device enabled state and during a transition from the energy storage device enabled state to the energy storage device disabled. In some aspects, the method may include resetting the power switch if a reset control signal is in a reset state.

Still another aspect of the invention may provide an apparatus including an energy storage device, first circuit components, second circuit components, and a power switch. The power switch may be configured to disconnect the energy storage device from the first and second circuit components such that current cannot leak from the energy storage device to the first and second circuit components in an energy storage device disabled state and connect the energy storage device to at least the second circuit components in an energy storage device enabled state.

In some aspects, the power switch may be configured to enter the energy storage device disabled state if a first control signal is in a disable energy storage device state and a second control signal is not in an energy storage device power state, and the power switch may be configured to enter the energy storage device enabled state if the first control signal is in an enable energy storage device state.

Yet another aspect of the invention may provide a method. The method may include using a power switch of an apparatus to disconnect an energy storage device of the apparatus from first and second circuit components of the apparatus such that current cannot leak from the energy storage device to the first and second circuit components in an energy storage device disabled state. The method may include using the power switch to connect the energy storage device to at least the second circuit components in an energy storage device enabled state.

Still another aspect of the invention may provide an apparatus including a primary energy storage device, a secondary energy storage device, and a power switch. A first terminal of the primary energy storage device may be connected to a first terminal of the secondary energy storage device. The primary energy storage device may have greater energy storage capacity than the secondary energy storage device, and the secondary energy storage device may have greater power delivery than the primary storage energy storage device. The power switch may be configured to disconnect a second terminal of the primary energy storage device from a second terminal of the secondary energy storage device such that current cannot leak across the secondary energy storage device if the power switch is in an energy storage device disabled state. The power switch may be configured to connect the second terminal of the primary energy storage device to the second terminal of the secondary energy storage device such that the secondary energy storage device adds to the power delivery capability of the primary energy storage device if the power switch is in an energy storage device enabled state.

In some aspects, the power switch may include third switches, and the power switch may be configured to connect the second terminal of the primary energy storage device to the second terminal of the secondary energy storage device by closing the third switches and disconnect the second terminal of the primary energy storage device from the second terminal of the capacitor by opening the third switches. In some aspects, the primary energy storage device may be a battery, fuel cell, or supercapacitor, and the secondary energy storage device may be a capacitor.

Yet another aspect of the invention may provide a method. The method may include using a power switch of an apparatus to disconnect a second terminal of a primary energy storage device of the apparatus from a second terminal of a secondary energy storage device of the apparatus such that current cannot leak across the secondary energy storage device if the power switch is in an energy storage device disabled state. The primary energy storage device may have greater energy storage capacity than the secondary energy storage device, and the secondary energy storage device may have greater power delivery than the primary energy storage device. A first terminal of the primary energy storage device may be connected to a first terminal of the secondary energy storage device. The method may include using the power switch to connect the second terminal of the primary energy storage device to the second terminal of the secondary energy storage device such that the secondary energy storage device adds to the power delivery capability of the primary energy storage device if the power switch is in an energy storage device enabled state.

In some aspects, using the power switch to disconnect the second terminal of the primary energy storage device from the second terminal of the secondary energy storage device may include opening third switches of the power switch, and using the power switch to connect the second terminal of the primary energy storage device to the second terminal of the secondary energy storage device may include closing the third switches.

Further variations encompassed within the systems and methods are described in the detailed description of the invention below.

### BRIEF DESCRIPTION OF THE DRAWINGS

The accompanying drawings, which are incorporated herein and form part of the specification, illustrate various, non-limiting aspects of the present invention. In the drawings, like reference numbers indicate identical or functionally similar elements.

FIG. 1 is a schematic view illustrating a system according to some aspects.

FIG. 2A is a block diagram of an apparatus of the system according to some aspects.

FIG. 2B is a block diagram of an apparatus of the system that includes two devices according to some aspects.

FIG. 2C is a block diagram of an apparatus of the system showing details of the power switch according to some aspects.

FIG. 3A is a block diagram of an analyte sensor of an analyte monitoring system according to some aspects.

FIG. 3B is a block diagram of an analyte sensor of an analyte monitoring system that includes two sensing devices according to some aspects.

FIG. 3C is a schematic view of circuitry of an analyte sensor of an analyte monitoring system according to some aspects.

FIG. 4 is a schematic view illustrating an exemplary transceiver of the analyte monitoring system according to some aspects.

FIG. 5 is a schematic view illustrating an exemplary display device of the analyte monitoring system according to some aspects.

FIG. 6 is a schematic view illustrating an exemplary computer of the system according to some aspects.

FIG. 7 is a flowchart illustrating a process according to some aspects.

FIG. 8 is a flowchart illustrating a process according to some aspects.

FIG. 9 is a flowchart illustrating a process according to some aspects.

FIG. 10 is a flowchart illustrating a process according to some aspects.

### DETAILED DESCRIPTION OF PREFERRED EMBODIMENTS

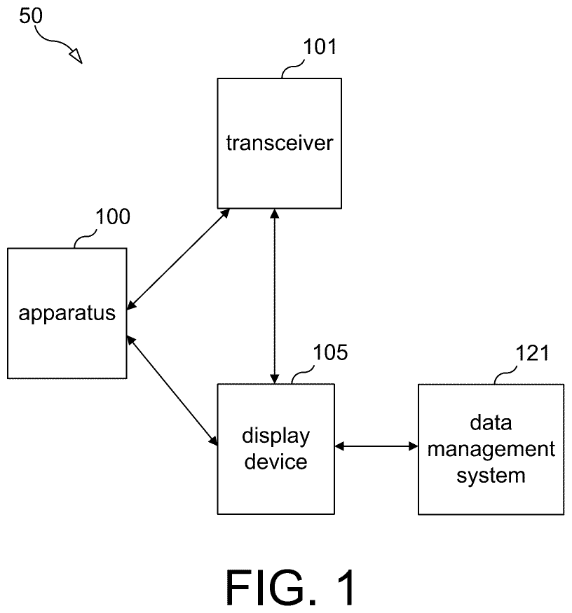

FIG. 1 is a schematic view of an exemplary system 50 embodying aspects of the present invention. In some aspects, the system 50 may be an analyte monitoring system (e.g., a continuous analyte monitoring system such as a continuous glucose monitoring system). In some aspects, the system 50 may include an apparatus 100, a transceiver 101, a display device 105, and/or a data management system (DMS) 121. In some aspects, the DMS 121 may be hosted by a remote server or network attached storage hardware.

In some aspects, the apparatus 100 may be an implantable device. In some aspects, the apparatus 100 may be a wireless implantable device. In some aspects, the apparatus 100 may be a sensor (e.g., an analyte sensor). In some aspects, the apparatus 100 may include one or more optical sensors (e.g., one or more fluorometers). In some aspects, the apparatus 100 may be chemical or biochemical sensors. In some aspects, the apparatus 100 may be a radio frequency identification (RFID) device. In some aspects, the apparatus 100 may be a small, fully subcutaneously implantable sensor that detects the presence, amount, and/or concentration of an analyte (e.g., glucose, oxygen, cardiac markers, low-density lipoprotein (LDL), high-density lipoprotein (HDL), or triglycerides) in a medium (e.g., interstitial fluid) of a living animal (e.g., a living human). However, this is not required, and, in some alternative aspects, the apparatus 100 may be a partially implantable (e.g., transcutaneous) device or a fully external sensor. In addition, although aspects of the invention are described with respect to an analyte monitoring system in which the apparatus 100 is an analyte sensor, this is not required. In some alternative aspects, the apparatus 100 is not a sensor and is instead a different type of apparatus, such as, for example and without limitation, an insulin pump (e.g., an implantable insulin pump), a pacemaker (e.g., an implantable pacemaker), or electrical/heat therapy device (e.g., an implantable electrical/heat therapy device).

In some aspects, the transceiver 101 may be an externally worn transceiver (e.g., attached via an armband, wristband, waistband, or adhesive patch). In some aspects, the transceiver 101 may remotely power and/or communicate with the apparatus 100 to initiate and receive the measurements (e.g., via near field communication (NFC) or far field communication). However, this is not required, and, in some alternative aspects, the transceiver 101 may power and/or communicate with the apparatus 100 via one or more wired connections. In some aspects, the transceiver 101 may be a smartphone (e.g., an NFC-enabled smartphone). In some aspects, the transceiver 101 may communicate information (e.g., one or more analyte concentrations) wirelessly (e.g., via a Bluetooth™ communication standard such as, for example and without limitation Bluetooth Low Energy) to a mobile medical application running on a display device 105 (e.g., a smartphone such as, for example, an NFC-enabled smartphone). In some aspects, the system 50 may include a web interface for plotting and sharing of uploaded data.

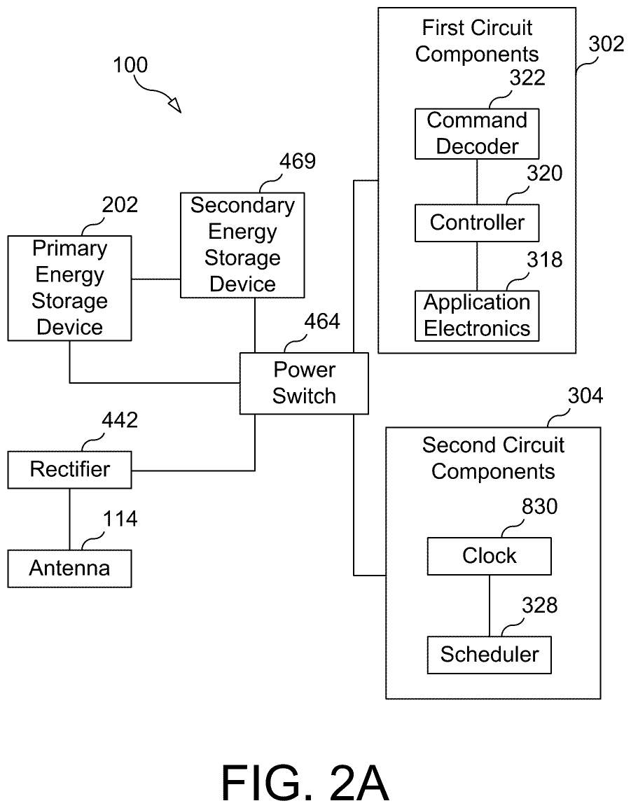

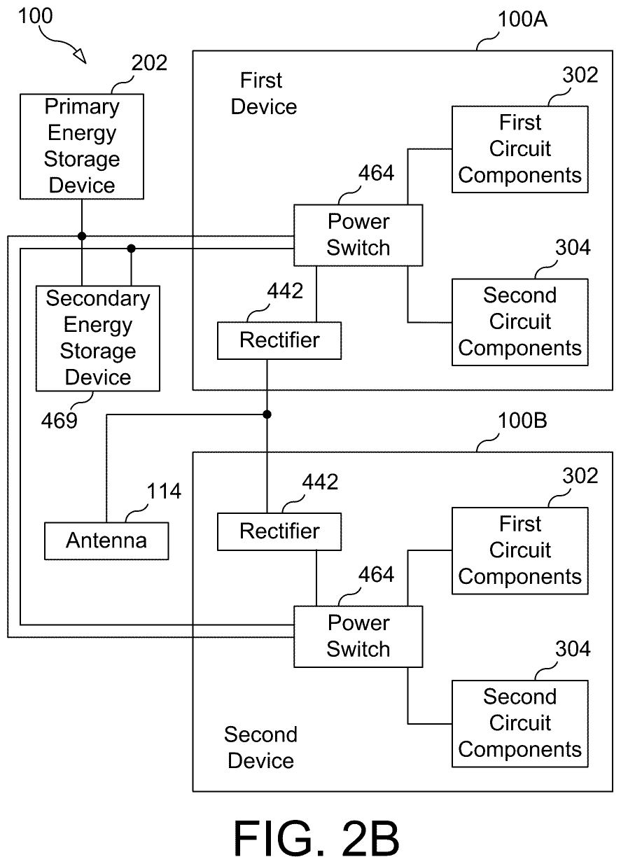

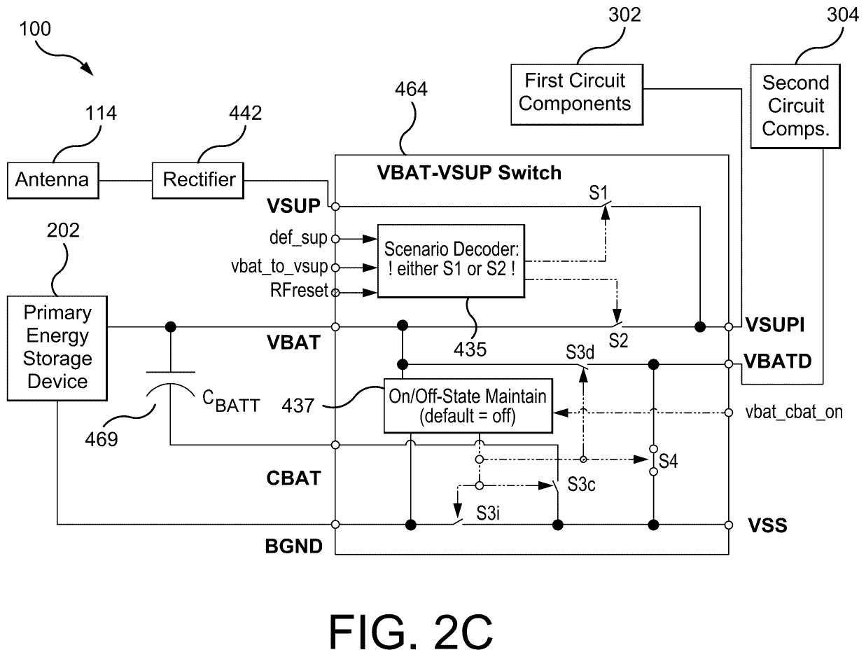

In some aspects, as shown in FIGS. 2A and 2B, the apparatus 100 may include a primary energy storage device (ESD) 202, first circuit components 302, second circuit components 304, an antenna 114, a rectifier 442, a secondary energy storage device 469, and/or a power switch 464. In some aspects, the primary energy storage device 202 may be, for example, a battery, fuel cell, or supercapacitor. In some aspects, at least the exterior of the primary energy storage device 202 may be made of a biocompatible material such as, for example and without limitation, stainless steel or a titanium alloy. In some aspects, the primary energy storage device 202 may be a titanium-cased, hermetically-sealed battery.

In some aspects, the antenna 114 may be configured to generate an alternating current when in an electromagnetic field. In some aspects, the antenna 114 may be in the form of a coil. In some aspects, the rectifier 442 may be configured to convert the alternating current to direct current.

In some aspects, as shown in FIG. 2C, the power switch 464 may include one or more switches (e.g., switches S1, S2, S3c, S3d, S3i, and S4). In some aspects, the switches may be any kind of switches known the in art including, for example, diodes, BJT transistors, MOSFETs, Silicon Controlled Rectifier (SCR), Insulated Gate Bipolar Transistors (IGBTs), thyristor based semiconductors, etc. In some aspects, the switches may include switch-on-transistors and switch-off-transistors. In some aspects, as shown in FIG. 2C, the power switch 464 may include one or more controllers that control the one or more switches in response to one or more control signals. However, this is not required, and, in some alternative aspects (e.g., some alternative aspects in which the power switch 464 does not include any controllers), the one or more of the switches may be controlled directly by one or more of the control signals received by the power switch 464.

In some aspects, as shown in FIG. 2C, the power switch 464 may include a first controller 435 (e.g., Scenario Decoder) and a second controller 437 (e.g., On/Off-State Maintain). However, it is not required that the functionality of the first and second controllers 435 and 437 be provided by two separate controllers, and, in some alternative aspects, the functionality of the first and second controllers 435 and 437 may be provided by a single controller or by more than two controllers (e.g., three or four controllers).

In some aspects, as shown in FIG. 2C, the power switch 464 may keep at least the second controller 437 connected to (and powered by) the primary energy storage device 202 at all times. In some aspects, the power switch 464 may keep only the second controller 437 connected to (and powered by) the primary energy storage device 202 at all times.

In some aspects, the power switch 464 may be configured to disconnect the primary energy storage device 202 from the first and second circuit components 302 and 304 such that current cannot leak from the primary energy storage device 202 to the first and second circuit components 302 and 304 in an energy storage device disabled state. In some aspects, the power switch 464 may additionally connect the rectifier 442 to the first circuit components 302 in the energy storage device disabled state. In some aspects, the power switch 464 may be configured to connect the primary energy storage device 202 to at least the second circuit components 304 in an energy storage device enabled state.

In some aspects, as shown in FIG. 2C, the power switch 464 may include a first switch S1, and the power switch 464 is configured to connect the rectifier 442 to the first circuit components 302 when the first switch S1 is closed and disconnect the rectifier 442 from the primary energy storage device 202 and the first circuit components 302 when the first switch S1 is open. In some aspects, as shown in FIG. 2C, the power switch 464 may additionally or alternatively include a second switch S2, and the power switch 464 may be configured to connect the primary energy storage device 202 to the first circuit components 302 when the second switch S2 is closed and disconnect the primary energy storage device 202 from the rectifier 442 and the first circuit components 302 when the second switch S2 is open.

In some aspects, the power switch 464 may be configured to enter the energy storage device disabled state if a first control signal (e.g., vbat_cbat_on in FIG. 2C) is in a disable energy storage device state (e.g., vbat_cbat_on=0) and a second control signal (e.g., vbat_to_vsup in FIG. 2C) is in a rectifier power state (e.g., vbat_to_vsup=0). In some aspects, the power switch 464 may be configured to enter the energy storage device enabled state if the first control signal is in an enable energy storage device state (e.g., vbat_cbat_on=1). In some aspects, the power switch 464 may be configured to connect the primary energy storage device 202 to the first circuit components 302 and disconnect the rectifier 442 from the first circuit components 302 and the primary energy storage device 202 if the first control signal is in the enable energy storage device state (e.g., vbat_cbat_on=1) and the second control signal is in an energy storage device power state (e.g., vbat_to_vsup=1). In some aspects, the power switch 464 may be configured to connect the rectifier 442 to the first circuit components 302 and disconnect the primary energy storage device 202 from the first circuit components 302 and the rectifier 442 if the first control signal is in the enable energy storage device state (e.g., vbat_cbat_on=1) and the second control signal is in the rectifier power state (e.g., vbat_to_vsup=0).

In some aspects, as shown in FIG. 2A, the second circuit components 304 may include a clock 830 and a scheduler 328 configured to count cycles of the clock 830 and periodically set the second control signal from the rectifier power state (e.g., vbat_to_vsup=0) to the energy storage device power state (e.g., vbat_to_vsup=1). In some aspects, as shown in FIG. 2A, the first circuit components 302 may include a controller 320 and application electronics 318 (e.g., a measurement controller and measurement electronics, respectively, in some aspects in which the apparatus 100 is a sensor; a pacemaker controller and pacemaking electronics, respectively, in some aspects in which the apparatus 100 is a pacemaker, or an electrical/heat therapy controller and electrical/heat therapy electronics in some aspects in which the apparatus 100 is an electrical/heat therapy device). In some aspects, the controller 320 may be configured to control the application electronics 318 to perform a sequence (e.g., a measurement controller may be configured to cause the measurement electronics to perform a measurement sequence in some aspects in which the apparatus 100 is a sensor, a pacemaker controller may be configured to cause the pacemaking electronics to perform a pacemaking sequence in some aspects in which the apparatus 100 is a pacemaker, or an electrical/heat therapy controller may cause electrical/heat therapy electronics to perform an electrical/heat therapy sequence in some aspects in which the apparatus 100 is an electrical/heat therapy device).

In some aspects, as shown in FIG. 2A, the first circuit components 302 may additionally or alternative include a command decoder 322 configured to decode commands in data extracted from the alternating current generated by the antenna 114. In some aspects, the command decoder 322 may be configured to set the first control signal to the disable energy storage device state (e.g., vbat_cbat_on=0) if the command decoder 302 decodes a disable energy storage device command and to set the first control signal to the enable energy storage device state (e.g., vbat_cbat_on=1) if the command decoder 322 decodes an enable energy storage device command.

In some aspects, the power switch 464 may be configured to connect the primary energy storage device 202 to the first circuit components 302 and disconnect the rectifier 442 from the first circuit components 302 and the primary energy storage device 202 if the first control signal is in the enable energy storage device state (e.g., vbat_cbat_on=1) and a third control signal (e.g., def_sup in FIG. 2C) is in an energy storage device power state (e.g., def_sup=0). In some aspects, the power switch 464 may be configured to connect the rectifier 442 to the first circuit components 302 and disconnect the primary energy storage device 202 from the first circuit components 302 and the rectifier 442 if the first control signal is in the enable energy storage device state (e.g., vbat_cbat_on=1) and the third control signal is in a rectifier power state (e.g., def_sup=1).

In some aspects, the secondary energy storage device 469 may be a capacitor. For example, in some aspects in which the primary energy storage device 202 is a battery or a fuel cell, the secondary energy storage device 469 may be a ceramic capacitor or a supercapacitor, and, in some aspects in which the primary energy storage device 202 is a supercapacitor, the secondary energy storage device 469 may be a ceramic capacitor. In some aspects, the primary energy storage device 202 may have greater energy storage capacity than the secondary energy storage device 469. In some aspects, the secondary energy storage device 469 may have greater power delivery than the primary energy storage device 202. In some aspects, the secondary energy storage device 469 may decrease the effective impedance of the primary energy storage device 202 and thus increase a peak driving capability of the primary energy storage device 202. In some aspects, as shown in FIG. 2C, a first terminal of the primary energy storage device 202 may be connected to a first terminal of the secondary energy storage device 469. In some aspects, the power switch 464 may be configured to disconnect a second terminal of the primary energy storage device 202 from a second terminal of the secondary energy storage device 469 such that current cannot leak across the secondary energy storage device 469 if the power switch 464 is in the energy storage device disabled state. In some aspects, the power switch 464 may be configured to connect the second terminal of the primary energy storage device 202 to the second terminal of the secondary energy storage device 469 such that the secondary energy storage device 469 adds to the power delivery capability of the primary energy storage device 202 if the power switch 464 is in the energy storage device enabled state. In some aspects, as shown in FIG. 2C, the power switch 464 may include third switches S3c, S3d, and S3i. In some aspects, the power switch 464 may be configured to connect the first terminal of the primary energy storage device 202 to the second circuit components 304 and connect the second terminal of the primary energy storage device 202 to the second terminal of the secondary energy storage device 469 when the third switches S3c, S3d, and S3i are closed and disconnect the first terminal of the primary energy storage device 202 from the second circuit components 304 and disconnect the second terminal of the primary energy storage device 202 from the second terminal of the secondary energy storage device 469 by opening the third switches S3c, S3d, and S3i.

In some aspects, as shown in FIG. 2C, the power switch 464 may include a fourth switch S4. In some aspects, the power switch 464 may be configured to prevent the primary energy storage device 202 from supplying power to the second circuit components 304 when the fourth switch S4 is closed. In some aspects, the power switch 464 may be configured to be reset during a transition from the energy storage device disabled state to the energy storage device enabled state and during a transition from the energy storage device enabled state to the energy storage device disabled. In some aspects, the power switch 464 may be further configured to be reset if a reset control signal (e.g., RFreset in FIG. 2C) is in a reset state (e.g., RFreset=1).

In some aspects, as shown in FIG. 2C, the power switch 464 may implement an analog control scheme. However, this is not required, and, in some alternative aspects, the power switch 464 may implement a digital control scheme or a hybrid control scheme. In some aspects, as shown in FIG. 2C, the control scheme of the power switch may switch the rectified voltage VSUP from the rectifier 442 and the energy storage device voltage VBAT to the supply voltage VSUPI, which may be an unregulated supply voltage, for the first circuit components 302. In some aspects, the power switch 464 may allow for two different power supply scenarios: (1) VSUP power supply from an electromagnetic field through the rectifier 442 and (2) VBAT power supply from the primary energy storage device 202. In some aspects, the power switch 464 may be additionally or alternatively configured to connect the primary energy storage device 202 to the second circuit components 306 so that the second circuit components 306 are powered by the VBAT power supply from the primary energy storage device 202.

In some aspects, as shown in FIG. 2C, the power switch 464 may include switches S1, S2, S3c, S3i, and S3d, which may be, for example, switch-on-transistors, and switch S4, which may be, for example, a switch-off transistor S4. In some aspects, the third switch S3d (default: OFF) and fourth switch S4 (default: ON) may ensure clean off-state at VBATD such that the second circuit components 304 do not face any unwanted supply voltage as long as the connection between the primary energy storage device 202 and ground is disabled. In some aspects, the third switches S3c, S3i, and S3d and fourth switch S4 may be controlled via the first control signal (e.g., vbat_cbat_on), which may be provided by the first circuit components 302. In some aspects, the third control signal (e.g., def_sup) may define the supply selection for the first circuit components 302 when the primary energy storage device 202 is connected and enabled. In some aspects, the second control signal (e.g., vbat_to_vsup) may come from the second circuit components 304 (e.g., the scheduler 328 of the second circuit components 304) and may define the supply in autonomous operation (e.g., autonomous measurement operation). In some aspects, based on the states of second and third control signals (e.g., vbat_to_vsup and def_sup), the first controller 435 may set the states of first and second switches S1 and S2 to either select energy storage device power VBAT (S2 closed, S1 open) or RF field power VSUP (S1 closed, S2 open) as a source for VSUPI. In some aspects, to achieve a safe battery operation, the power switch 464 may ensure that no current can flow from VSUP into VBAT.

In some aspects, the first circuit components 302 may be powered up via VSUP, and, once an enable energy storage device command is received by the command decoder 322, the command decoder 322 may change the state of the first control signal (e.g., vbat_cbat_on) to open the fourth switch S4 and close third switches S3c, S3i, S3d. In some aspects, the state of the first and second switches S1 and S2 may depend on the state of second control signal (e.g., vbat_to_vsup). In some alternative aspects, if it is desired to power the first circuit components 302 completely off the primary energy storage device 202, then the second switch S2 will always be closed and the first switch S1 always open.

In some aspects, once the disable energy storage device command is received by the command decoder 322, the command decoder 322 may change the state of the first control signal (e.g., vbat_cbat_on) to open switches the third switches S3c, S3i, S3d and close the fourth switch S4. In some aspects, the second switch S2 may be set to open and the first switch S1 may be set to closed by the first controller 435 by the apparatus 100 changing the level of third control signal (e.g., def_sup).

In some aspects, the power switch 464 may ensure that neither the primary energy storage device 202 nor the rectifier 442 shorts to ground. In some aspects, the power switch 464 may additionally or alternatively accommodate the voltage VBAT from the primary energy storage device 202 not taking a long time to come up to level after switching due to charging up the large capacitance of the secondary energy storage device 469. In some aspects, the power switch 464 may ensure that no current can flow back from VSUP to VBAT (especially if VSUP is greater than or equal to VBAT). In some aspects (e.g., some aspects in which the primary energy storage device 202 is not rechargeable), ensuring that no current can flow back from VSUP to VBAT may protect the primary energy storage device 202 from damage. However, in some aspects, in order to minimize the voltage drop from VBAT towards VSUPI, the power switch 464 may ensure no current can flow from VSUP to VBAT without the use of a diode between VBAT and VBAD or VSUPI. In some aspects, the power switch 464 may be reset at any change from VSUP to VBAT (or vice versa).

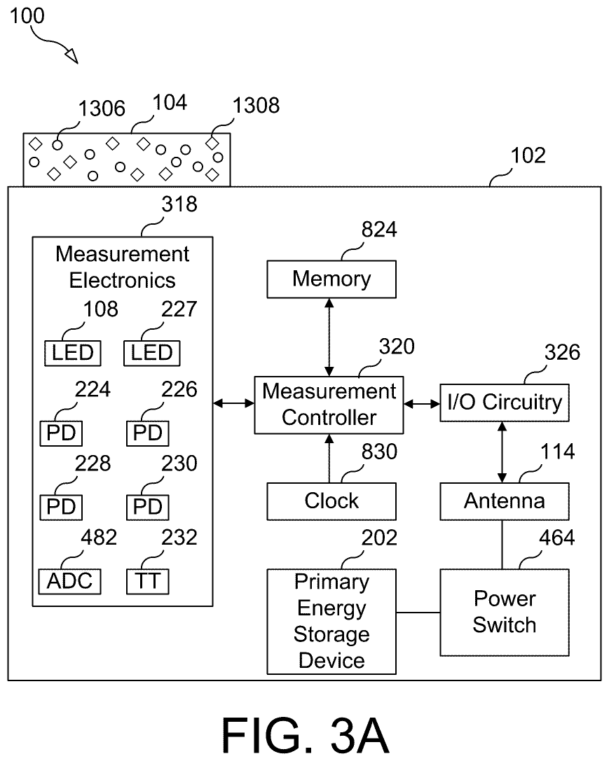

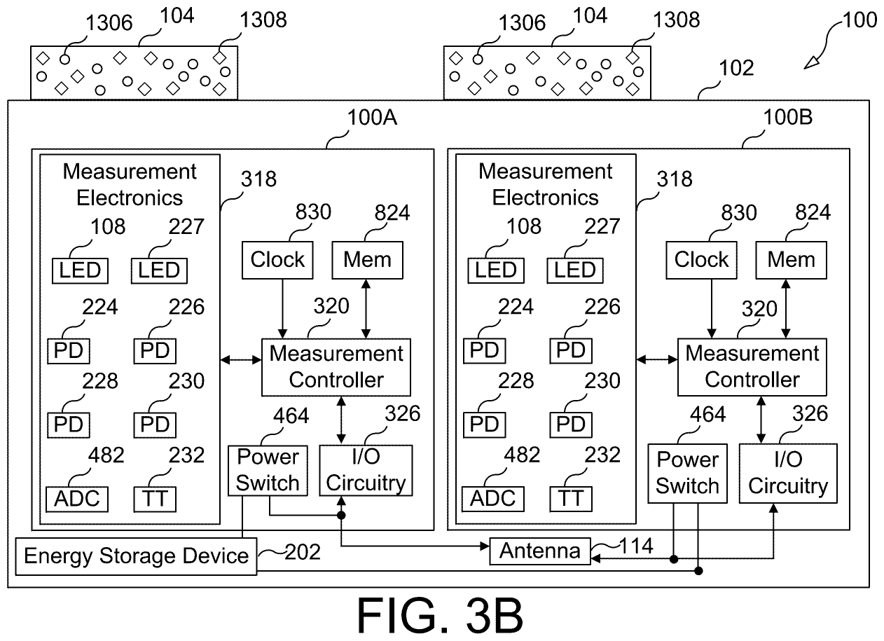

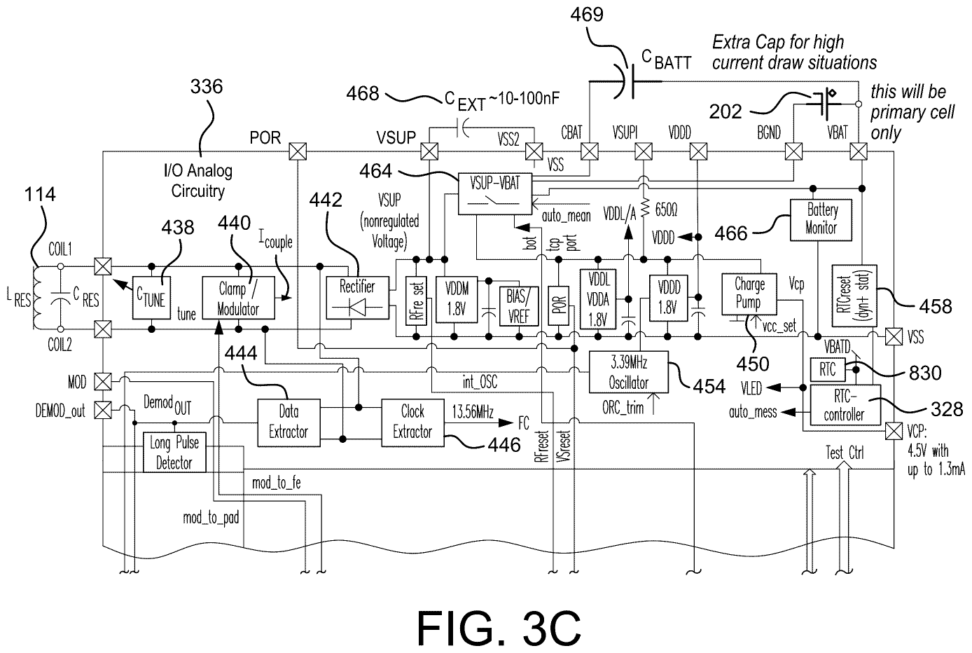

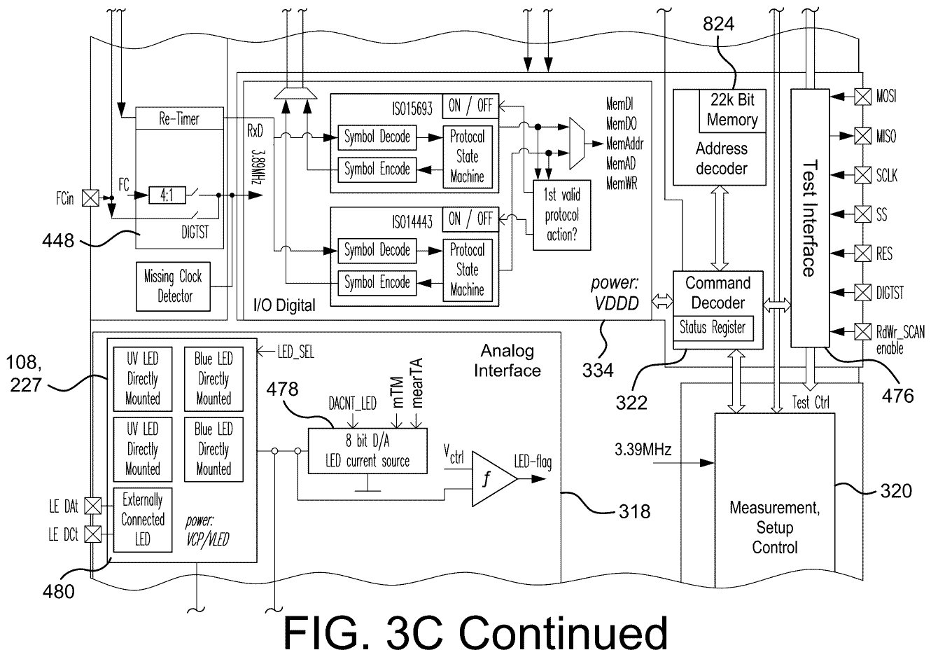

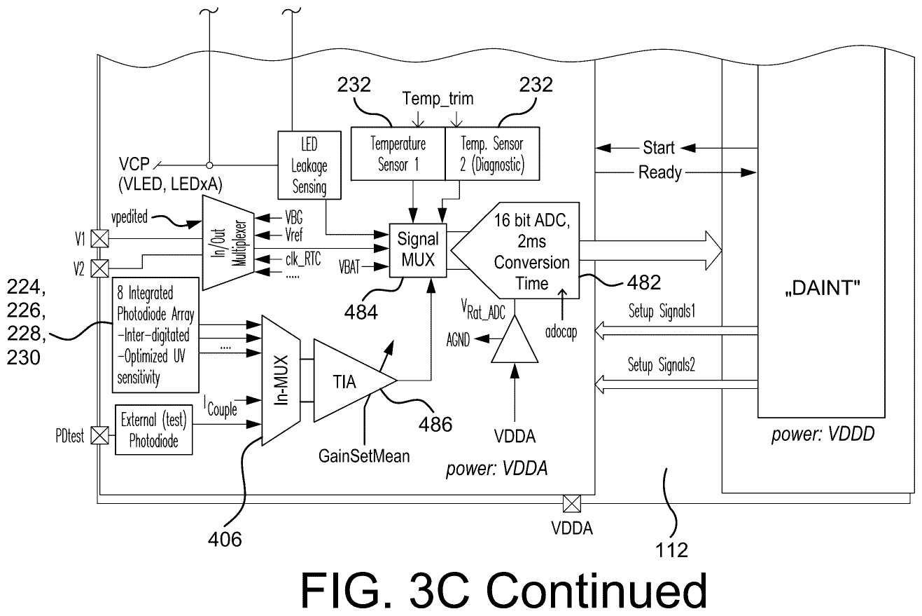

FIGS. 3A-3C illustrate exemplary aspects in which the apparatus 100 of the system 50 is a fully implantable electro-optical sensor. However, this is not required, and, in some alternative aspects, the apparatus 100 may be a different type of analyte sensor (e.g., a transcutaneous electrochemical sensor) or a different type of apparatus (e.g., an insulin pump, a pacemaker, or electrical/heat therapy device). In some aspects, as shown in FIGS. 3A and 3B, the apparatus 100 may include a housing 102 (i.e., body, shell, capsule, or encasement), which may be rigid and biocompatible. In some aspects, the housing 102 may be a silicon tube. However, this is not required, and, in other aspects, different materials and/or shapes may be used for the housing 102. In some aspects, the apparatus 100 may include a transmissive optical cavity (e.g., within the housing 102). In some aspects, the transmissive optical cavity may be formed from a suitable, optically transmissive polymer material, such as, for example, acrylic polymers (e.g., polymethylmethacrylate (PMMA)). However, this is not required, and, in other aspects, different materials may be used for the transmissive optical cavity.

In some aspects, as shown in FIGS. 3A and 3B, the apparatus 100 may include analyte and/or interferent indicator material 104, which may be, for example, polymer grafts or hydrogels coated, diffused, adhered, embedded, or grown on or in one or more portions of the exterior surface of the housing 102. In some aspects, the analyte and/or interferent indicator material 104, may be porous and may allow the analyte (e.g., glucose) in a medium (e.g., interstitial fluid) to diffuse into the analyte and/or interferent indicator material 104.

In some aspects, as shown in FIGS. 3A and 3B, the analyte and/or interferent indicator material 104 may include analyte indicator molecules 1306 and/or interferent indicator molecules 1308 (e.g., degradation indicator molecules). In some aspects, the apparatus 100 may use the analyte indicator molecules 1306 to measure the presence, amount, and/or concentration of an analyte (e.g., glucose, oxygen, cardiac markers, low-density lipoprotein (LDL), high-density lipoprotein (HDL), or triglycerides). In some aspects, the apparatus 100 may use the interferent indicator molecules 1308 to measure in vivo (e.g., ROS induced) signal degradation. In some aspects, in the analyte and/or interferent indicator material 104, the analyte indicator molecules 1306 and/or the interferent indicator molecules 1308 may be copolymerized into a single biocompatible hydrogel. In some aspects, the analyte indicator molecules 1306 and/or the interferent indicator molecules 1308 may have negligible spectral overlap and undergo similar degradation (e.g., similar degradation of boronic acids) in vivo.

In some aspects, the analyte indicator molecules 1306 may have one or more detectable properties (e.g., optical properties) that vary in accordance with (i) the amount or concentration of the analyte in proximity to the analyte and/or interferent indicator material 104 and (ii) an effect on the analyte indicator molecules 1306 (e.g., changes to the analyte indicator molecules 1306). In some aspects, the changes to the analyte indicator molecules 1306 may comprise the extent to which the analyte indicator molecules 1306 have degraded. In some aspects, the degradation may be (at least in part) ROS-induced oxidation. In some aspects, the analyte indicator molecules 1306 may be fluorescent analyte indicator molecules. In some aspects, the analyte indicator molecules 1306 may be distributed throughout the analyte and/or interferent indicator material 104. In some aspects, the analyte indicator molecules 1306 may be phenylboronic-based analyte indicator molecules. However, a phenylboronic-based analyte indicator is not required, and, in some alternative aspects, the apparatus 100 may include different analyte indicator molecules, such as, for example and without limitation, glucose oxidase-based indicators, glucose dehydrogenase-based indicators, and glucose binding protein-based indicators.

In some aspects, the interferent indicator molecules 1308 may have one or more detectable properties (e.g., optical properties) that vary in accordance with changes to the interferent indicator molecules 1308. In some aspects, the interferent indicator molecules 1308 are not sensitive to the amount of concentration of the analyte in proximity to the analyte and/or interferent indicator material 104. That is, in some aspects, the one or more detectable properties of the interferent indicator molecules 1308 do not vary in accordance with the amount or concentration of the analyte in proximity to the analyte and/or interferent indicator material 104. However, this is not required, and, in some alternative aspects, the one or more detectable properties of interferent indicator molecules 1308 may vary in accordance with the amount or concentration of the analyte in proximity to the analyte and/or interferent indicator material 104.

In some aspects, the changes to the interferent indicator molecules 1308 may comprise the extent to which the interferent indicator molecules 1308 have degraded. In some aspects, the degradation may be (at least in part) ROS-induced oxidation. In some aspects, the interferent indicator molecules 1308 may be fluorescent interferent indicator molecules. In some aspects, the interferent indicator molecules 1308 may be distributed throughout the analyte and/or interferent indicator material 104. In some aspects, the interferent indicator molecules 1308 may be phenylboronic-based interferent indicator molecules. However, phenylboronic-based interferent indicator molecules are not required, and, in some alternative aspects, the apparatus 100 may include different interferent indicator molecules 1308, such as, for example and without limitation, amplex red-based interferent indicator molecules, dichlorodihydrofluorescein-based interferent indicator molecules, dihydrorhodamine-based interferent indicator molecules, and scopoletin-based interferent indicator molecules.

In some aspects, the analyte monitoring system 50 may use the interferent indicator molecules 1308 of the analyte and/or interferent indicator material 104, which may by sensitive to degradation by reactive oxygen species (ROS) but not sensitive to the analyte, to measure indirectly changes to the analyte indicator molecules 1306 of an analyte and/or interferent indicator material 104. In some aspects, the interferent indicator molecules 1308 may have one or more optical properties that change with extent of oxidation and may be used as a reference for measuring and correcting for extent of oxidation of the analyte indicator molecules 1306. In some aspects, the extent to which the interferent indicator molecules 1308 have degraded may correspond to the extent to which the analyte indicator molecules 1306 have degraded. For example, in aspects, the extent to which the interferent indicator molecules 1308 have degraded may be proportional to the extent to which the analyte indicator molecules 1306 have degraded. In some aspects, the extent to which the analyte indicator molecules 1306 have degraded may be calculated based on the extent to which the interferent indicator molecules 1308 have degraded. In some aspects, the system 50 may correct for changes in the analyte indicator molecules 1306 using an empiric correlation established through laboratory testing.

In some aspects, as shown in FIGS. 3A and 3B, the apparatus 100 may include measurement electronics 318 (e.g., optical measurement electronics). In some aspects, the measurement electronics 318 may include one or more light sources and/or one or more photodetectors. For example, in some aspects, as shown in FIGS. 3A and 3B, the measurement electronics 318 may include one or more first light sources 108 that emit first excitation light over a wavelength range that interacts with the analyte indicator molecules 1306 in the analyte and/or interferent indicator material 104. In some aspects, the first excitation light may be ultraviolet (UV) light. In some aspects, the apparatus 100 may include one or more second light sources 227 that emit second excitation light over a wavelength range that interacts with the interferent indicator molecules 1308 in the analyte and/or interferent indicator material 104. In some aspects, the second excitation light may be, for example and without limitation, blue light.

In some aspects, the analyte indicator molecules 1306 may emit first emission light (e.g., fluorescent light) when irradiated by the first excitation light. In some aspects, an analyte (e.g., glucose) may bind reversibly to some of the analyte indicator molecules 1306, and the amount of first emission light emitted by an analyte indicator molecule 1306 may vary based on whether the analyte is bound to the analyte indicator molecule 1306. For example, when irradiated by the first excitation light, an analyte indicator molecule 1306 may emit a relatively large amount of first emission light if the analyte is bound to analyte indicator molecule 1306 and may emit a relatively small amount of first emission light 331 (or no first emission light 331) if analyte is not bound to the analyte indicator molecule 1306. Therefore, the amount of first emission light emitted by the analyte indicator molecules 1306 may vary based on the concentration of the analyte in proximity to the analyte and/or interferent indicator material 104. In some aspects, the amount of first emission light emitted by the analyte indicator molecule 1306 may also vary based on an amount of interference (e.g., the extent to which the analyte indicator molecules 1306 have degraded).

In some aspects, the interferent indicator molecules 1308 may emit second emission light (e.g., fluorescent light) when irradiated by the second excitation light. In some aspects, the amount of second emission light emitted by the interferent indicator molecules 1308 may vary based on an amount of interference (e.g., the extent to which the interferent indicator molecules 1308 have degraded). In some aspects, the amount of second emission light emitted by the interferent indicator molecules 1308 does not vary based on the concentration of the analyte in proximity to the analyte and/or interferent indicator material 104. In some aspects, degradation (e.g., oxidation) of the interferent indicator molecules 1308 may additionally or alternatively cause the absorption of the interferent indicator molecules 1308 (e.g., absorption of the second excitation light by the interferent indicator molecules 1308) to change.

In some aspects, as shown in FIGS. 3A and 3B, the measurement electronics 318 of the apparatus 100 may also include one or more photodetectors 224, 226, 228 (e.g., photodiodes, phototransistors, photoresistors, or other photosensitive elements). In some aspects, the measurement electronics 318 of the apparatus 100 may include one or more signal photodetectors 224 sensitive to first emission light (e.g., fluorescent light) emitted by the analyte indicator molecules 1306 such that a signal generated by a signal photodetector 224 is indicative of the level of first emission light of the analyte indicator molecules 1306 and, thus, the amount of analyte of interest (e.g., glucose). In some aspects, the measurement electronics 318 may include one or more reference photodetectors 226 sensitive to first excitation light that may be reflected from the analyte and/or interferent indicator material 104 such that a signal generated by a photodetector 226 in response thereto is indicative of the level of reflected first excitation light. In some aspects, the apparatus 100 may include one or more interferent photodetectors 228 sensitive to second emission light (e.g., fluorescent light) emitted by the interferent indicator molecules 1308 such that a signal generated by an interferent photodetector 228 in response thereto that is indicative of the level of second emission light of the interferent indicator molecules 1308 and, thus, the amount of degradation (e.g., oxidation). In some aspects, the one or more signal photodetectors 224 may be sensitive to second excitation light that may be reflected from the analyte and/or interferent indicator material 104. In this way, the one or more signal photodetectors 224 may act as reference photodetectors when the one or more second light sources 227 are emitting second excitation light.

However, it is not required that the one or more signal photodetectors 224 act as reference photodetectors when the one or more second light sources 227 are emitting second excitation light. In some alternative aspects, as shown in FIGS. 3A and 3B, the measurement electronics 318 of the apparatus 100 may include one or more second reference photodetectors 230 that act as reference photodetectors when the one or more second light sources 227 are emitting second excitation light. In some aspects, the one or more second reference photodetectors 230 may be sensitive to second excitation light that may be reflected from the analyte and/or interferent indicator material 104 such that a signal generated by a photodetector 230 in response thereto is indicative of the level of reflected second excitation light.

In some aspects, one or more of the photodetectors 224, 226, 228, 230 may be covered by one or more filters that allow only a certain subset of wavelengths of light to pass through and reflect (or absorb) the remaining wavelengths. In some aspects, one or more filters on the one or more signal photodetectors 224 may allow only a subset of wavelengths corresponding to first emission light and/or the reflected second excitation light. In some aspects, one or more filters on the one or more reference photodetectors 226 may allow only a subset of wavelengths corresponding to the reflected first excitation light. In some aspects, one or more filters on the one or more interferent photodetectors 228 may allow only a subset of wavelengths corresponding to second emission light. In some aspects in which the apparatus 100 includes one or more second reference photodetectors 230, one or more filters on the one or more second reference photodetectors 230 may allow only a subset of wavelengths corresponding to the reflected second excitation light.

In some aspects, as shown in FIGS. 3A and 3B, the measurement electronics 318 of the apparatus 100 may include one or more temperature transducers 232. In some aspects, the measurement electronics 318 may include one or more light source drivers, one or more amplifiers, one or more analog-to-digital convertors (ADCs) 482, one or more comparators, and/or one or more multiplexors. In some aspects, the one or more ADCs 482 may convert analog signals output by the photodetectors 224, 226, 228, 230 and/or one or more temperature transducers 232 to digital signals.

In some aspects, as shown in FIGS. 3A and 3B, the apparatus 100 may include a primary energy storage device 202, a measurement controller 320, a memory 824, a clock 830, input/output (I/O) circuitry 326, and/or an antenna 114. In some aspects, the apparatus 100 (e.g., the circuitry 270 of the apparatus 100) may be powered at least partially by the primary energy storage device 202. In some aspects, as shown in the FIGS. 3A and 3B, the primary energy storage device 202 may be in the housing 102 of the apparatus 100. However, this is not required, and, in some alternative aspects, the primary energy storage device 202 may be external to the housing 102. In some alternative aspects in which the energy storage device 202 is external to the housing 102, the primary energy storage device 202 may be attached to the housing 102 (e.g., via a coupler).

In some aspects, the I/O circuitry 326 may include I/O digital circuitry 334 and/or I/O analog circuitry 336 (see FIG. 3C). In some aspects, the antenna 114 may be electrically connected to the I/O circuitry 326, which may use current flowing through the antenna 114 to generate power for the apparatus 100 and/or to extract data from the current. In some aspects, the I/O circuitry 326 may also convey data (e.g., to the transceiver 101 and/or display device 105) by modulating the current flowing through the antenna 114. In some aspects, the I/O circuitry 326 may (at least at times) be electrically connected to and powered by the primary energy storage device 202.

In some aspects, when electrically connected to and powered by the primary energy storage device 202, the clock 830 may provide a continuous clock for driving circuitry of the apparatus 100 (e.g., even when the apparatus 100 is not receiving power from an external device such as the transceiver 101 and/or the display device 105). In some aspects, the measurement controller 320 may be a computer. In some aspects, the apparatus 100 may use the continuous clock output of the clock 830 to keep track of time and initiate autonomous, self-powered analyte measurements when appropriate (e.g., at periodic intervals, such as, for example, every minute, every two minutes, every 5 minutes, every 10 minutes, every 15 minutes, every half-hour, every hour, every two hours, every six hours, every twelve hours, or every day). In some aspects, the measurement controller 320 may control the measurement electronics 318 to perform an autonomous analyte measurement sequence, and the results of the autonomous analyte measurement may be stored in the memory 824. The autonomous analyte measurements may be stored in the memory 824. In some aspects, the I/O circuitry 326 may convey one or more of the stored measurements to the external device (e.g., the transceiver 101 and/or the display device 105) at a later time. For example, in some request aspects, the I/O circuitry 326 may convey one or more of the stored measurements in response to the apparatus 100 receiving and decoding a measurement data request from the transceiver 101 and/or the display device 105. In some alternative aspects, the I/O circuitry 326 may convey one or more of the stored measurements in response to detecting that the transceiver 101 and/or display device 105 is present (e.g., when an electrodynamic field generated by the transceiver 101 and/or display device 105 induces a current in the antenna 114 of the apparatus 100).

In some aspects, the memory 824 may be a nonvolatile storage medium. In some aspects, the memory 824 may be an electrically erasable programmable read only memory (EEPROM). However, in some alternative aspects, other types of nonvolatile storage media, such as flash memory, may be used. In some aspects, the memory 824 may include an address decoder. In some aspects, the memory 824 may store measurement information autonomously generated while the apparatus 100 is powered from the primary energy storage device 202. In some aspects, the memory 824 may additionally or alternatively store one or more time-stamps identifying when the measurement data was generated, sensor calibration data, a unique sensor identification, setup information, and/or integrated circuit calibration data. In some aspects, the unique identification information may, for example, enable full traceability of the apparatus 100 through its production and subsequent use.

In some aspects, as shown in FIG. 3A, the apparatus 100 may include one sensing device, which may include the measurement electronics 318 that interact with (e.g., emits excitation light to and detects light reflected and/or emitted by) the analyte and/or interferent indicator material 104. However, this is not required, and, in some alternative aspects, the apparatus 100 may include a different number of sensing devices (e.g., two, three, four, five, ten, etc.). For example, as shown in FIG. 3B, the apparatus 100 may include first and second sensing devices 100A and 100B. In some aspects, the sensing devices 100A and 100B may each include measurement electronics 318 that interact with analyte and/or interferent indicator material 104 on a portion 106 of the exterior surface of the housing 102. In some aspects, the sensing devices 100A and 100B may share a primary energy storage device 202 and/or an antenna 114. That is, in some aspects in which the apparatus 100 includes multiple sensing devices, the antenna 114 may be electrically connected to the circuitry of the multiple sensing devices (e.g., sensing devices 100A and 100B), and the primary energy storage device 202 may be connected to the circuitry of the multiple sensing devices.

FIG. 3C is a block diagram illustrating the functional blocks of circuitry of the apparatus 100 (e.g., circuitry of a sensing of a sensing device 100A or 100B of the apparatus 100) according to some aspects. In some aspects, as illustrated in FIG. 3C, the circuitry may include circuit components mounted on or fabricated in a substrate 112 of the apparatus 100. In some aspects, the substrate 112 may be a circuit board (e.g., a printed circuit board (PCB) or flexible PCB) on which one or more of the circuit components (e.g., analog and/or digital circuit components) may be mounted or otherwise attached. However, in some alternative aspects, the substrate 112 may be a semiconductor substrate having one or more of the circuit components fabricated therein. For instance, the fabricated circuit components may include analog and/or digital circuitry. Also, in some aspects in which the substrate 112 is a semiconductor substrate, in addition to the circuit components fabricated in the semiconductor substrate, circuit components may be mounted or otherwise attached to the semiconductor substrate. In other words, in some semiconductor substrate aspects, a portion or all of the circuit components, which may include discrete circuit elements, an integrated circuit (e.g., an application specific integrated circuit (ASIC)) and/or other electronic components (e.g., a non-volatile memory), may be fabricated in the semiconductor substrate with the remainder of the circuit components secured to the semiconductor substrate, which may provide communication paths between the various secured components.

In some aspects, the circuit components mounted on or fabricated in the substrate 112 may include the measurement electronics 318, the measurement controller 320, a command decoder 322, the memory 824, the input/output (I/O) circuitry 326, a scheduler 328, and the clock 830. In some aspects, the scheduler 328 may issue an autonomous measurement command (e.g., to the command decoder 322, which may decode the command and/or send the command to the measurement controller 320, or directly to the measurement controller 320. The measurement controller 320 may control the measurement electronics 318 to perform an autonomous analyte measurement sequence, and the results of the autonomous analyte measurement may be stored in the memory 824. In some alternative aspects, instead of issuing an autonomous measurement command that is decoded by the command decoder 322, the scheduler 328 may communicate with the measurement controller 320 initiate the performance of the autonomous analyte measurement sequence. In some aspects, the autonomous measurement command may be a control signal that changes a state (e.g., from low to high or from high to low) to initiate the performance of the autonomous analyte measurement sequence. In some further alternative aspects, the functionality of the scheduler 328 may be included in the measurement controller 320, and, in these aspects, the measurement controller 320 may use the clock 830 to determine when to perform the autonomous analyte measurement sequence.

In some aspects, as shown in FIG. 3C, the I/O circuitry 326 may include I/O digital circuitry 334 and/or I/O analog circuitry 336. In some aspects, as shown in FIG. 3C, the antenna 114, which may be in the form of a coil, may be external to the substrate 112 and may be connected to the I/O analog circuitry 336 of the I/O circuitry 326 through contacts COIL1 and COIL2. In some aspects in which the apparatus 100 includes multiple sensing devices (e.g., as shown in FIG. 3B), although not shown in FIG. 3C, the antenna 114 may be electrically connected to the circuitry of the multiple sensing devices.

In some aspects, as shown in FIG. 3C, the I/O analog circuitry 336 may include one or more of a capacitor 438, clamp/modulator 440, a rectifier 442, a data extractor 444, a clock extractor 446, a frequency divider 448, a charge pump 450, and an oscillator 454. In some aspects, one or more of the capacitor 438, clamp/modulator 440, rectifier 442, data extractor 444, and clock extractor 446 may be connected to the antenna 114 through one or more of contacts COIL1 and COIL2. The rectifier 442 may convert an alternating current produced by the antenna 114 to a direct current that may be used to power circuit components of the apparatus 100. For example, the direct current may be used to produce one or more voltages, such as, for example, voltages VDDL or VDDA, which may be used to power the measurement electronics 318, and/or VDDD, which may be used to power one or more of the I/O digital circuit 334, the memory 824, the measurement controller 320, the command decoder 322, the scheduler 328, and/or a test interface 476. In some aspects, the rectifier 442 may be a Schottky diode; however, other types of rectifiers may be used in some alternative embodiments. In some aspects, the data extractor 444 may extract data from the alternating current produced by the antenna 114. In some aspects, the clock extractor 446 may extract a signal having a frequency (e.g., 13.56 MHz) from the alternating current produced by the antenna 114. In some aspects, the frequency divider 448 may divide the frequency of the signal output by the clock extractor 446. For example, in some aspects, the frequency divider 448 may comprise a 4:1 frequency divider that receives a signal having a frequency (e.g., 13.56 MHz) as an input and outputs a signal having a frequency (e.g., 3.39 MHz) equal to one fourth the frequency of the input signal. In some aspects, the frequency divider 448 may output either the frequency divided output of the clock extractor 446 or the output of the oscillator 454 to the I/O digital circuitry 334. In some aspects, the outputs of rectifier 442 may be connected to one or more capacitors 468 (e.g., one or more regulation capacitors) through contacts VSUP and VSS.

In some aspects, as shown in FIG. 3C, the I/O analog circuitry 336 may include a charge pump 450. In some aspects, the charge pump 450 may produce a voltage VLED that is used to power the one or more light sources 108, 227. In some aspects, the charge pump 450 may additionally or alternatively produce a voltage of the charge pump (VCP).

In some aspects, the primary ESD 202 may be electrically connected to circuitry of the substrate 112 (e.g., via contacts VBAT and BGND). In some aspects in which the apparatus 100 includes multiple sensing devices, although not shown in FIG. 3C, the primary ESD 202 may be electrically connected to the circuitry of the multiple sensing devices. In some aspects, the apparatus 100 may include a secondary energy storage device 469 connected to circuitry of a substrate 112 (e.g., via contacts VBAT and CBAT). In some aspects, the secondary energy storage device 469 may be for high current draw situations.

In some aspects, as shown in FIG. 3C, the I/O analog circuitry 336 may include a power switch 464. In some aspects, the power switch 464 may switch the circuitry of a substrate 112 between ESD power provided by the primary energy storage device 202 and externally supplied power provided by an external device (e.g., the transceiver 101 or the display device 105) via the antenna 114 and rectifier 442. In some aspects, the power switch 464 may switch circuit components of the substrate 112 of the apparatus 100 from being powered by the voltage VSUP produced by the rectifier 442 using a current induced in the antenna 114 to being powered by the voltage VBAT produced by the primary energy storage device 202.

In some aspects, the power switch 464 may switch the circuitry of a substrate 112 of the apparatus 100 to power itself from the power of the primary energy storage device 202 in response to an autonomous measurement command initiated by the scheduler 328. For instance, in some aspects, the circuitry of a substrate 112 of the apparatus 100 may be in a sleep mode while the apparatus 100 is not receiving power from an external device (e.g., the transceiver 101 or the display device 105). In the sleep mode, no power would be supplied to at least a subset of the circuit components of the substate 112 (e.g., one or more of the I/O digital circuitry 334, command decoder 322, memory 824, measurement controller 320, and measurement electronics 318). However, in some aspects, in the sleep mode, at least the clock 830 and scheduler 328 would receive power from the primary energy storage device 202. The scheduler 328 may use the ESD-powered clock 830 to determine when to initiate an autonomous measurement. In some aspects, in response to an autonomous measurement command from the scheduler 328, the power switch 464 may switch circuitry of a substrate 112 of the apparatus 100 to the power of the primary energy storage device 202. In some aspects, one or more of the I/O digital circuitry 334, command decoder 322, memory 824, measurement controller 320, and measurement electronics 318 would then be powered by the primary energy storage device 202. In some aspects, when the apparatus 100 is switched to the power of the primary energy storage device 202, the voltage VBAT (instead of the voltage VSUP) may be used to produce the voltage (e.g., voltages VDDA, VDDD, and VLED) that powers the apparatus 100. In this way, the scheduler 328 can wake up the apparatus 100 by issuing a measurement command that causes the power switch 464 to switch the apparatus 100 to the power of the primary energy storage device 202.

In some aspects, the clock 830 may be a pseudo real time clock (RTC). In some aspects, as described above, the circuitry of a substrate 112 of the apparatus 100 may use the clock 830 to realize the sleep mode during which the apparatus 100 (or sensing device of the apparatus 100) is in a low power mode while the apparatus 100 waits to take another autonomous measurement. In some aspects, during the sleep/low power mode, the primary ESD 202 may power the clock 830 and the scheduler 328 but may not provide power to the subset of the circuit components of the apparatus 100 or sensing device thereof (e.g., one or more of the I/O digital circuitry 334, command decoder 322, memory 824, measurement controller 320, and measurement electronics 318). In some aspects, the number of clock cycles that the apparatus 100 (or sensing device thereof) will wait during sleep period may be programmed into a rtc_ref_value in the memory 824.

In some aspects, as shown in FIG. 3C, the I/O analog circuitry 334 may include an ESD monitor 466 configured to monitor the voltage VBAT produced by the primary energy storage device 202 and provide feedback about the energy level of the primary energy storage device 202. For instance, in some aspects, the ESD monitor 466 may indicate whether the voltage VBAT is sufficient for operation of the apparatus 100 (or sensing device thereof), and the power switch 464 may only switch the apparatus 100 (or sending device thereof) to ESD power if the ESD monitor 466 indicates that the voltage VBAT is sufficient for sensor operation. In some aspects, the ESD monitor 466 may determine whether the voltage VBAT is sufficient for sensor operation by comparing the voltage VBAT to an operational threshold voltage. In some aspects, the scheduler 328 may adjust the frequency at which autonomous measurements are taken based on the energy level of the primary energy storage device 202 as indicated by the ESD monitor 466. For instance, in some aspects, if the ESD monitor 466 indicates that the energy level of the primary energy storage device 202 is low, the scheduler 328 may adjust the frequency at which autonomous measurements are taken.

In some aspects, as shown in FIG. 3C, the I/O digital circuitry 334 may include a decoder, an encoder, and a protocol state machine. In some aspects, the decoder may decode the data extracted by the data extractor 444 from the alternating current produced by antenna 114. In some aspects, the command decoder 322 may receive the data decoded by the decoder and may decode commands therefrom. In some aspects, the command decoder 322 may comprise a status register. In some aspects, the encoder may receive data from the command decoder 322 and encode the data. In some aspects, the I/O digital circuitry 334 may include two or more sets of encoders and decoders with each set having its own protocol state machine. In this way, the apparatus 100 (or sensing device thereof) may be able to convey and receive information using more than one communication protocol. For example, in some aspects, as shown in FIG. 3C, the I/O digital circuitry 334 may include an ISO14443 decoder, encoder, and protocol state machine set and an ISO15693 decoder, encoder, and protocol state machine set.

In some aspects, as shown in FIG. 3C, the clamp/modulator 440 of the I/O analog circuitry 336 may receive the data encoded by the encoder 472 and may modulate the current flowing through the antenna 114 as a function of the encoded data. In this way, the encoded data may be conveyed wirelessly by the antenna 114 as a modulated electromagnetic wave. In some aspects, the conveyed data may be detected by an external reading device (e.g., the transceiver 101 and/or display device 105) by, for example, measuring the current induced by the modulated electromagnetic wave in a coil of the external reading device. Furthermore, by modulating the current flowing through the antenna 114 as a function of the encoded data, the encoded data may be conveyed wirelessly by the antenna 114 as a modulated electromagnetic wave even while the antenna 114 is being used to produce operating power for the apparatus 100. In some aspects, the communications received by the antenna 114 and/or the communications conveyed by the antenna 114 may be radio frequency (RF) communications. Although, in the illustrated aspect, the apparatus 100 includes a single antenna 114, some alternative aspects of the apparatus 100 may include two or more inductive elements (e.g., one coil for data conveyance and one coil for power and data reception).

In some aspects, as shown in FIG. 3C, the measurement electronics 318 may include a current source 478, one or more light source drivers 480, an analog to digital converter (ADC) 482, a signal multiplexer (MUX) 484, a comparator 486, one or more photodetectors 224, 226, 228, and/or 230, and/or one or more temperature transducers 232. In some aspects, the comparator 486 may be a transimpedance amplifier (TIA). However, this is not required, and, in some alternative aspects, the comparator 486 may be a different type of comparator. In some aspects, one or more of the temperature transducers 232 may be a band-gap based temperature transducer. However, in some alternative embodiments, different types of temperature transducers may be used, such as, for example, thermistors or resistance temperature detectors. In some aspects, the measurement electronics 318 may include two temperature transducers 232 for high reliability operation and for detection of temperature error/failure with higher probability. In some aspects, the second temperature transducer 232 may be a redundant temperature transducer that is the same as the first temperature transducer 232 and may be for temperature plausibility/diagnostic purposes. In some aspects, the one or more temperature transducers 232 may be fabricated in the substrate 112 or mounted on the semiconductor substrate 112. The one or more temperature transducers 232 may output an analog temperature measurement signal indicative of the temperature of the apparatus 100.

In some aspects, the one or more light source drivers 480 may drive the one or more light sources 108, 227 using current provided by the current source 478. In some aspects, the one or more light sources 108 of the apparatus 100 may include a first light source 108 (e.g., a UV light source) and a second light source 227 (e.g., a blue light source). In some aspects, as illustrated in FIG. 3C, the first and second light sources 108, 227 may be mounted to the substrate 112 and connected to the substrate 112 via contacts. However, this is not required, and, in some alternative aspects, one or more of the first and second light sources 108, 227 may be fabricated in the substrate 112. In some aspects, the one or more light sources may be powered using a voltage VLED generated using the charge pump 450. In some aspects, the one or more light source drivers 480 may receive a light source selection signal from the measurement controller 320 that identifies which of the one or more light sources 108, 227 should be driven by the one or more light source drivers 480.

In some aspects, the current source 478 may receive a signal from the measurement controller 320 indicating the light source current at which a light source 108, 227 is to be driven, and the current source 478 may provide a current accordingly. In some aspects, the one or more light sources 108, 227 may emit radiation from an emission point in accordance with one or more drive signals from the one or more light source drivers 480. In some aspects, the one or more photodetectors 224, 226, 228, 230 may each output an analog light measurement signal indicative of the amount of light received by the photodetector.

In some aspects, as shown in FIG. 3C, the measurement electronics 318 may include an input multiplexor 406. In some aspects, the input multiplexor 406 may receive the analog light measurement signals outputted by the one or more photodetectors 224, 226, 228, 230. In some aspects, under the control of the measurement controller 320, the input multiplexor 406 may select one or two of the analog light measurement signals to pass through to the comparator 486. In some aspects, the comparator 486 may amplify and/or compare the one or more analog light measurement signals received from the input multiplexor 406.

In some aspects, as shown in FIG. 3C, the signal MUX 484 may receive one or more analog temperature measurement signals from the one or more temperature transducers 232, one or more analog light measurement signals from the one or more photodetectors 224, 226, 228, 230, an analog light difference measurement signal from the comparator 486, and/or one more analog voltage measurements signals from the ESD monitor 466. In some aspects, under the control of the measurement controller 320, the signal MUX 484 may select one of the received signals and output the selected signal to the ADC 482. In some aspects, the ADC 482 may receive the selected analog signal from the signal MUX 484, convert the received analog signal to a digital signal, and supply the digital signal to the measurement controller 320. In this way, the ADC 482 may convert the one or more analog temperature measurement signals, the one or more analog light measurement signals, and/or the analog light difference measurement signal, and/or the one or more analog short term measurements to one or more digital temperature measurement signals, one or more digital light measurement signals, and/or a digital light difference measurement signal, respectively. In some aspects, the ADC 482 may supply the digital signals, one at a time, to the measurement controller 320. In some aspects, the ADC 482 may be a 16 bit ADC, and the ADC 482 may have, for example, a 2 ms conversion time. However, this is not required, and some alternative aspects may use a different ADC.

In some aspects, the circuitry of the apparatus 100 (or sensing device thereof) may include a field strength measurement circuit. In some aspects, the field strength measurement circuit may be part of the I/O analog circuitry 336, I/O digital circuitry 334, or the measurement controller 320, or the field strength measurement circuit may be a separate functional component. In some aspects, the field strength measurement circuit may measure the received (i.e., coupled) power (e.g., in mWatts). The field strength measurement circuit of the apparatus 100 may produce a coupling value proportional to the strength of coupling between the antenna 114 of the apparatus 100 and an antenna of an external device (e.g., transceiver 101 and/or display device 105). For example, in some aspects, the coupling value may be a current or frequency proportional to the strength of coupling.

In some aspects, as illustrated in FIG. 3C, the clamp/modulator 440 of the I/O analog circuitry 336 acts as the field strength measurement circuit by providing a value (e.g., Icouple) proportional to the field strength. In some aspects, the field strength value Icouple may be provided as an input to the signal MUX 484 (e.g., via the input MUX 406). When selected, the signal MUX 484 may output the field strength value Icouple to the ADC 482. The ADC 482 may convert the field strength value Icouple received from the signal MUX 484 to a digital field strength value signal and supply the digital field strength signal to the measurement controller 320. In this way, the field strength measurement may be made available to the measurement controller 320 (e.g., for determining whether the field strength is sufficient to carry out a measurement sequence).

In some aspects, as shown in FIG. 3C, a test interface 476 may be mounted on or fabricated in the substrate 112. In some aspects, the test interface 476 may enable wafer-level production testing of the substrate 112. In some aspects, the test interface 476 may be an SPI-taped interface (i.e., a wireless communication interface). In some aspects, the test interface 476 may receive signals via one or more contacts and may output signals via one or more contacts. The test interface 476 may communicate with the measurement controller 320 via the command decoder 322.

In some aspects, as noted above with respect to FIG. 2A, the second circuit components 304 may include the clock 830 and the scheduler 328. In some aspects, the first circuit components may include measurement controller 320, measurement electronics 318 (e.g., photodetectors 224, 226, 228, and/or 230), and/or command decoder 322. In some aspects, the first circuit components may further include I/O digital circuitry 334, and/or memory 824 in addition to the measurement electronics 318 and the measurement controller 320.

In some aspects, as shown in FIG. 2C, the first switch S1 may be controlled by the first controller 435 (e.g., Scenario Decoder). In some aspects, as shown in FIG. 2C, the power switch 464 may be configured to connect voltage VSUP (e.g., voltage produced by the rectifier 442) to voltage VSUPI when closed the first switch S1 is closed. In some aspects, connecting the voltage VSUP to the voltage VSUPI may cause the first circuit components 302 (e.g., one or more of the I/O digital circuitry 334, command decoder 322, memory 824, measurement controller 320, and measurement electronics 318) to be powered by the rectifier 442. In some aspects, opening the first switch S1 may disconnect the voltage VSUP from voltage VSUPI. In some aspects, disconnecting the voltage VSUP to the voltage VSUPI may cause the first circuit components 302 (e.g., one or more of the I/O digital circuitry 334, command decoder 322, memory 824, measurement controller 320, and measurement electronics 318) to not be powered by the rectifier 442.

In some aspects, the power switch 464 may include a second switch S2. In some aspects, the power switch 464 may be configured to connect the primary energy storage device 202 to the first circuit components 302 when the second switch S2 is closed. In some aspects, the power switch 464 may be configured to disconnect the primary energy storage device 202 from the rectifier 442 and the first circuit components 302 when the second switch S2 is open.

In some aspects, the second switch S2 may be controlled by the first controller 435. In some aspects, as shown in FIG. 2C, the power switch 464 may be configured to connect voltage VBAT (e.g., voltage produced by the ESD 202) to voltage VSUPI when the second switch S2 is closed. In some aspects connecting the voltage VBAT to the voltage VSUP may cause the first circuit components 302 (e.g., one or more of the I/O digital circuitry 334, command decoder 322, memory 824, measurement controller 320, and measurement electronics 318) to be powered by the primary energy storage device 202. In some aspects, opening the second switch S2 may disconnect the voltage VBAT to the voltage VSUPI (e.g., disconnect the first circuit components 302 from the primary energy storage device 202). In some aspects disconnecting the voltage VBAT to the voltage VSUP may cause the first circuit components 302 (e.g., one or more of the I/O digital circuitry 334, command decoder 322, memory 824, measurement controller 320, and measurement electronics 318) to be not powered by the primary energy storage device 202. In some aspects, the power switch 464 may be configured so that the first switch S1 and the second switch S2 are not able to be closed at the same time.

In some aspects, the second controller 437 of the power switch 464 may control the one or more third switches S3c, S3d, and S3i. In some aspects, the power switch 464, as shown in FIG. 2C, may be configured to connect voltage VBAT to voltage VBATD and connect voltage VBAT to contact CBAT (e.g., contact CBAT connects to a bottom terminal of secondary energy storage device 469) when third switches S3i, S3c, S3d are closed. In some aspects, connecting voltage VBAT to contact CBAT may cause the second circuit components 304 (e.g., the scheduler 328 and the clock 830) to be powered by the primary energy storage device 202 and the secondary energy storage device 469 to be connected to primary energy storage device 202 (e.g., the primary energy storage device 202 is connected to both a top terminal and the bottom terminal of the secondary energy storage device 469). In some aspects, this may decrease the primary energy storage device 202 source impedance. In some aspects, opening the third switches S3i, S3c, and S3d may disconnect voltage VBAT from voltage VBATD and contact CBAT. In some aspects, disconnecting voltage VBAT to contact CBAT may cause the second circuit components 304 (e.g., the scheduler 328 and the clock 830) to be not be powered by the primary energy storage device 202 and the secondary energy storage device 469 to not be connected to primary energy storage device 202 (e.g., the primary energy storage device 202 is connected to both a top terminal and the bottom terminal of the secondary energy storage device 469). In some aspects, this may prevent current from leaking from the primary energy storage device 202 to the secondary energy storage device 469.

In some aspects, the second controller 437 may control the fourth switch S4. In some aspects, the power switch 464, as shown in FIG. 2C, may be configured to prevent voltage VSD from supplying power to voltage VBATD when the fourth switch S4 is closed. In some aspects, the primary energy storage device 202 may then be prevented from supplying power to the second circuit components 304 (e.g., the scheduler 328 and the clock 830).

In some aspects, if the first control signal is in a disable energy storage device state, the second controller 437 may open the third switches S3i, S3c, and S3d and close the fourth switch S4 so that voltage VBAT is unable to connect to voltage VBATD and contact CBAT. In some aspects, if the first control signal is in an enable energy storage device power state, the second controller 437 may close the third switches S3i, S3c, and S3d and open the fourth switch S4 so that voltage VBATD may connect to voltage VABTD and contact CBAT.

In some aspects, the command decoder 322 may decode a disable energy storage device command. Based on the decoded command, the command decoder 322 may set the first control signal to the enable energy storage device state. In some aspects, based on the first signal, the second controller 437 may open the fourth switch S4 and close the third switches S3i, S3c, and S3d. In some aspects, this may connect the primary energy storage device 202 to the second circuit components 304. In some aspects, the measurement controller 322 may have determined, based on the number of counted cycles of the clock 830, to the set and/or not change the second control signal from the rectifier power state. Based on the second control signal, the first controller 435 may close the first switch S1 and open the second switch S2. In some aspects, the measurement controller 322 may have determined, based on the number of counted cycles of the clock 830, to set and/or not change the second control signal from the energy storage device power state.

In some aspects, the command decoder 322 may decode a disable energy storage device command, and, based on the decoded command, the command decoder 322 may set the first control signal to the disable energy storage device state. Based on the first control signal, the second controller 437 may close fourth switch s4 and open the third switches S3c, S3i, and S3d. Additionally, based on the decoded command, the command decoder 322 may set the third control signal to the rectifier power state. Based on the third control signal, the first controller 435 may close the first switch S1 and open the second switch S2.

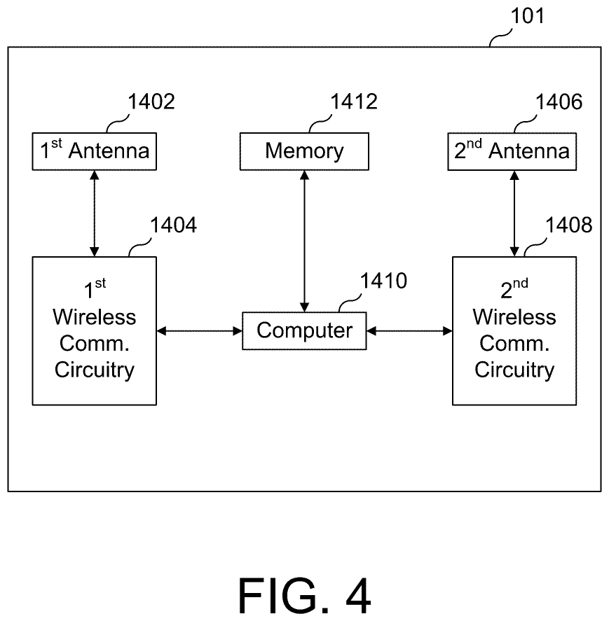

FIG. 4 illustrates an exemplary aspect in which the transceiver 101 of the system 50 is a wireless transceiver (e.g., a wireless on-body transceiver). However, this is not required, and, in some alternative aspects, the transceiver 101 may be a different type of transceiver (e.g., a transceiver having a wired connection to the apparatus 100). In some aspects, as shown in FIG. 4, the transceiver 101 may include a first antenna 1402, first wireless communication circuitry 1404, a second antenna 1406, second wireless communication circuitry 1408, a computer 1410, and/or a memory 1412. In some aspects, the computer 1410 may control the overall operation of the transceiver 101.

In some aspects, the transceiver 101 may include a sensor interface device. In some aspects, the sensor interface device of the transceiver 101 may include the first antenna 1402 and the first wireless communication circuitry 1404. In some aspects, the first wireless communication circuitry 1404 may enable the transceiver 101 to communicate directly with the apparatus 100. In some aspects, the transceiver 101 and the apparatus 100 may communicate using NFC (e.g. at a frequency of 13.56 MHz). In some aspects, the first antenna 1402 of the transceiver 101 may include an inductor (e.g. flat antenna, loop antenna, etc.) that is configured to permit adequate field strength to be achieved when brought within adequate physical proximity to the antenna 114 of the apparatus 100.

In some aspects, the transceiver 101 may use the first antenna 1402 and the first wireless communication circuitry 1404 to receive sensor data from the apparatus 100. In some aspects, the computer 1410 may store the received sensor data in the memory 1412. In some aspects, the memory 1412 may be non-volatile and/or capable of being electronically erased and/or rewritten. In some aspects, the memory 1412 may be, for example and without limitations, a Flash memory.

In some aspects, the received sensor data may include light measurements, temperature measurements, and time stamps. In some aspects, the computer 1410 may use the sensor data to calculate analyte levels (e.g., blood glucose levels). In some aspects, the computer 1410 may store the calculated analyte levels in the memory 1412.

In some aspects, the transceiver 101 may include a display interface device. In some aspects, the display device interface device may include the second antenna 1406 and the second wireless communication circuitry 1408. In some aspects, the second wireless communication circuitry 1408 may enable wireless communication by the transceiver 101 with one or more external devices, such as, for example, one or more personal computers, one or more other transceivers 101, and/or display devices 105 via the second antenna 1406. In some aspects, the second wireless communication circuitry 1408 may employ one or more wireless communication standards to wirelessly transmit data. The wireless communication standard employed may be any suitable wireless communication standard, such as an ANT standard, a Bluetooth standard, or a Bluetooth Low Energy (BLE) standard (e.g., BLE 4.0). In some aspects, the second antenna 1406 may be, for example and without limitation, a Bluetooth antenna.

In some aspects in which the transceiver 101 calculates analyte levels, the transceiver 101 may use the second antenna 1406 and the second wireless communication circuitry 1408 to convey calculated levels to the display device 105. In some aspects in which the transceiver 101 calculates and conveys analyte levels, the transceiver 101 may additionally convey the sensor data to the display device 105. In some alternative aspects, the transceiver 101 may not calculate analyte levels. In some aspects in which the transceiver 101 does not calculate analyte levels, the transceiver 101 may use the second antenna 1406 and the second wireless communication circuitry 1408 to convey sensor data to the display device 105, and the display device 105 may use the sensor data to calculate analyte levels.

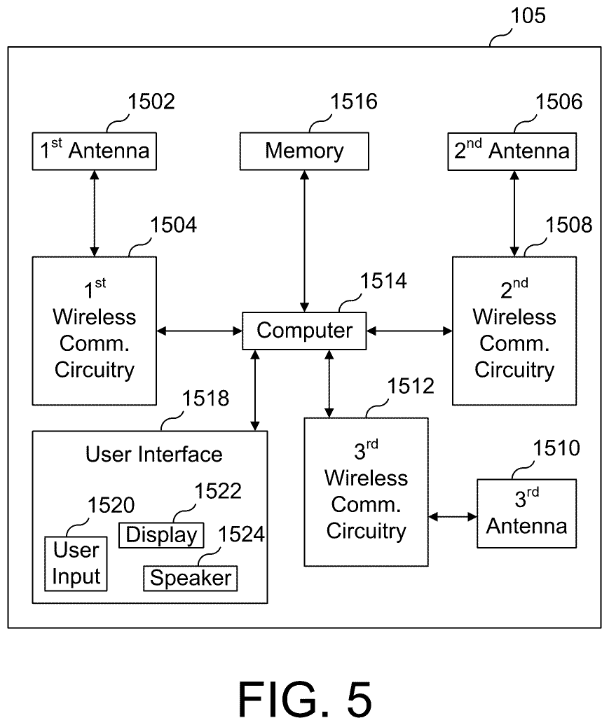

FIG. 5 is a block diagram of the display device 105 of the system 50 according to some aspects. In some aspects, as shown in FIG. 5, the display device 105 may include a first antenna 1502, first wireless communication circuitry 1504, second antenna 1506, second wireless communication circuitry 1508, third antenna 1510, third wireless communication circuitry 1512, a computer 1514, a memory 1516, and/or a user interface 1518. In some aspects, the computer 1514 may control the overall operation of the display device 105.

In some aspects, the display device 105 may include a sensor interface device. In some aspects, the sensor interface device of the display device 105 may include the first antenna 1502 and the first wireless communication circuitry 1504. In some aspects, the first wireless communication circuitry 1504 may enable the display device 105 to communicate directly with the apparatus 100. In some aspects, the display device 105 and the apparatus 100 may communicate using NFC (e.g. at a frequency of 13.56 MHz). In some aspects, the first antenna 1502 of the display device 105 may include an inductor (e.g. flat antenna, loop antenna, etc.) that is configured to permit adequate field strength to be achieved when brought within adequate physical proximity to the antenna 114 of the apparatus 100.

In some aspects, the display device 105 may use the first antenna 1502 and the first wireless communication circuitry 1504 to receive sensor data from the apparatus 100. In some aspects, the computer 1514 may store the received sensor data in the memory 1516. In some aspects, the memory 1516 may be non-volatile and/or capable of being electronically erased and/or rewritten. In some aspects, the memory 1516 may be, for example and without limitations, a Flash memory.

In some aspects, the received sensor data may include light measurements, temperature measurements, and time stamps. In some aspects, the computer 1514 may use the sensor data to calculate analyte levels (e.g., blood glucose levels). In some aspects, the computer 1514 may store the calculated analyte levels in the memory 1516.

In some aspects, the display device 105 may include a transceiver interface device. In some aspects, the transceiver interface device may include the second antenna 1506 and the second wireless communication circuitry 1508. In some aspects, the second wireless communication circuitry 1508 may enable wireless communication by the display device 105 with one or more external devices, such as, for example, one or more personal computers, one or more transceivers 101, and/or one or more other display devices 105 via the second antenna 1506. In some aspects, the second wireless communication circuitry 1508 may employ one or more wireless communication standards to wirelessly transmit data. The wireless communication standard employed may be any suitable wireless communication standard, such as an ANT standard, a Bluetooth standard, or a Bluetooth Low Energy (BLE) standard (e.g., BLE 4.0). In some aspects, the second antenna 1506 may be, for example and without limitation, a Bluetooth antenna.

In some aspects, the display device 105 may use the second antenna 1506 and the second wireless communication circuitry 1508 to receive sensor data and/or calculated analyte levels from the transceiver 101. In some aspects, the computer 1514 may store the received sensor data and/or the received calculated analyte levels in the memory 1516. In some aspects, the computer 1514 may use the sensor data to calculate analyte levels. In some aspects (e.g., some aspects in which the display device 105 does not receive calculated analyte levels from transceiver 101), the computer 1514 may calculate analyte levels based on the sensor data received from the transceiver 101. In some aspects, the computer 1514 may store the calculated analyte levels in the memory 1516.

In some aspects in which the display device 105 includes the third antenna 1510 and the third wireless communication circuitry 1512, the third antenna 1510 and the third wireless communication circuitry 1512 may enable the display device 105 to communicate with one or more remote devices (e.g., smartphones, servers, and/or personal computers) via wireless local area networks (e.g., Wi-Fi), cellular networks, and/or the Internet. In some aspects, the third wireless communication circuitry 1512 may employ one or more wireless communication standards to wirelessly transmit data. In some aspects, the third antenna 1510 may be, for example and without limitation, a Wi-Fi antenna and/or one or more cellular antennas.

In some aspects in which the display device 105 includes the user interface 1518, the user interface 1518 may include a display 1522 and/or a user input 1520. In some aspects, the display 1522 may be a liquid crystal display (LCD) and/or light emitting diode (LED) display. In some aspects, the user input 1520 may include one or more buttons, a keyboard, a keypad, and/or a touchscreen. In some aspects, the computer 1514 may control the display 1522 to display data (e.g., calculated analyte levels, analyte level trend information, alerts, alarms, and/or notifications). In some aspects, the user interface 1518 may include one or more of a speaker 1524 (e.g., a beeper) and a vibration motor, which may be activated, for example, in the event that a condition (e.g., a hypoglycemic or hyperglycemic condition) is met.

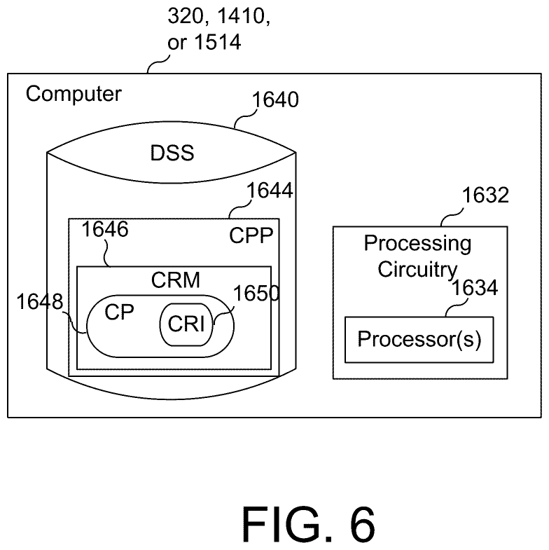

FIG. 6 is a block diagram of an aspect of a computer (e.g., the measurement controller 320 of the apparatus 100, the computer 1410 of the transceiver 101, and/or the computer 1514 of the display device 105) of the system 50. As shown in FIG. 6, in some aspects, the computer may include processing circuitry 1632 and/or one or more circuits, such as an application specific integrated circuit (ASIC), field-programmable gate arrays (FPGAs), a logic circuit, and the like. The processing circuitry 1632 may include one or more processors 1634 (e.g., one or more general purpose microprocessors). In some aspects, the computer may include a data storage system (DSS) 1640. The DSS 1640 may include one or more non-volatile storage devices and/or one or more volatile storage devices (e.g., random access memory (RAM)). In aspects where the computer includes processing circuitry 1632, the DSS 1640 may include a computer program product (CPP) 1644. CPP 1644 may include or be a computer readable medium (CRM) 1646. The CRM 1646 may store a computer program (CP) 1648 comprising computer readable instructions (CRI) 1650. In some aspects in which the computer is the computer 1514 of the display device 105, the CRM 1646 may store, among other programs, the MMA, and the CRI 1650 may include one or more instructions of the MMA. The CRM 1646 may be a non-transitory computer readable medium, such as, but not limited, to magnetic media (e.g., a hard disk), optical media (e.g., a DVD), solid state devices (e.g., random access memory (RAM) or flash memory), and the like. In some aspects, the CRI 1650 of computer program 1648 may be configured such that when executed by processing circuitry 1632, the CRI 1650 causes the computer to perform steps described below (e.g., steps described above with reference to process 700). In other aspects, the computer may be configured to perform steps described herein without the need for a computer program. That is, for example, the computer may consist merely of one or more ASICs. Hence, the features of the aspects described herein may be implemented in hardware and/or software.

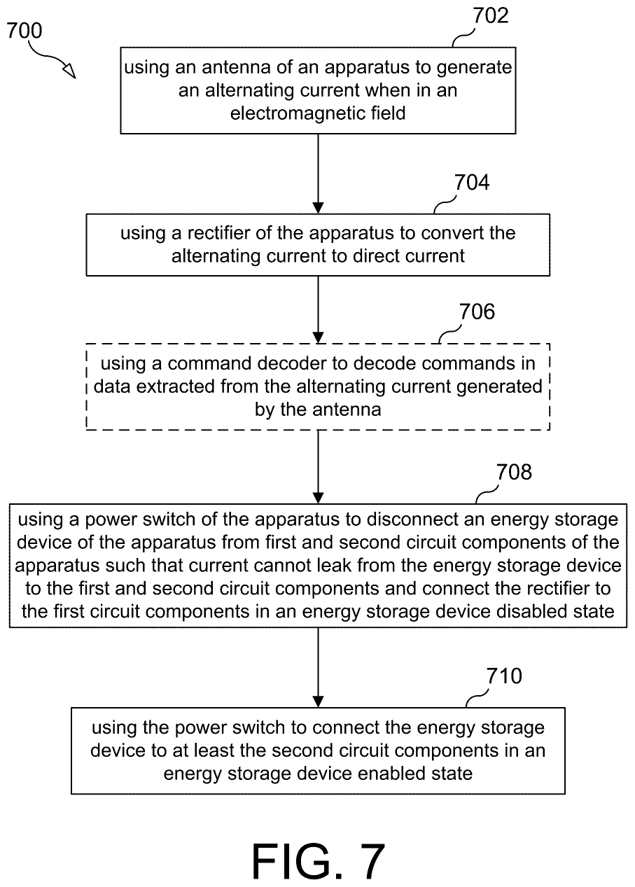

FIG. 7 is a flow chart illustrating a process 700 that may be performed by the system 50 according to some aspects. In some aspects, one or more steps of the method 700 may be performed by an apparatus 100 (e.g., an analyte sensor) of the system 50 (e.g., an analyte monitoring). In some aspects, as shown in FIG. 7, the process 700 may include a step 702 in which the apparatus 100 uses the antenna 114 to generate an alternating current when in an electromagnetic field.

In some aspects, as shown in FIG. 7, the process 700 may include a step 704 in which the apparatus 100 uses the rectifier 442 to convert the alternating current to direct current.

In some aspects in which the first circuit components include the command decoder 322, as shown in FIG. 7, the process 700 may include an optional step 706 of using the command decoder 322 to decode commands in data extracted from the alternating current generated by the antenna 114. In some aspects, the command decoder 322 may be configured to set a first control signal (e.g., vbat_cbat_on) to a disable energy storage device state (e.g., vbat_cbat_on=0) if the command decoder 322 decodes a disable energy storage device command and to set the first control signal to the enable energy storage device state (e.g., vbat_cbat_on=1) if the command decoder 322 decodes an enable energy storage device command.

In some aspects, as shown in FIG. 7, the process 700 may include a step 708 in which the apparatus 100 uses the power switch 464 to disconnect the primary energy storage device 202 from the first circuit components 302 (e.g., one or more of the I/O digital circuitry 334, command decoder 322, memory 824, measurement controller 320, and/or measurement electronics 318) and second circuit components 304 (e.g., scheduler 328 and clock 830) of the apparatus 100 such that current cannot leak from the primary energy storage device 202 to the first and second circuit components 302 and 304 and connect the rectifier 442 to the first circuit components 302 in an energy storage device disabled state. In some aspects, the power switch 464 may enter the energy storage device disabled state if the first control signal (e.g., vbat_cbat_on) is in the disable energy storage device state (e.g., vbat_cbat_on=0) and a second control signal (e.g., vbat_to_vsup) is in a rectifier power state (e.g., vbat_to_vsup=0).

In some aspects, as shown in FIG. 7, the process 700 may include a step 710 in which the apparatus 100 uses the power switch 464 to connect the primary energy storage device 202 to at least the second circuit components 304 (e.g., clock 830 and scheduler 328) in an energy storage device enabled state. In some aspects, the power switch 464 may enter the energy storage device enabled state if the first control signal is in an enable energy storage device state (e.g., vbat_cbat_on=1).

In some aspects, if the first control signal is in the enable energy storage device state (e.g., vbat_cbat_on=1) and the second control signal is in the rectifier power state (e.g., vbat_to_vsup=0), the apparatus 100 may use the power switch 464 to connect the rectifier 442 to the first circuit components 302 and disconnect the primary energy storage device 202 from the first circuit components 302 and the rectifier 442. In some aspects, if the first control signal is in the enable energy storage device state (e.g., vbat_cbat_on=1) and the second control signal is in an energy storage device power state (e.g., vbat_to_vsup=1), the apparatus 100 may use the power switch 464 to connect the primary energy storage device 202 to the first circuit components 302 and disconnect the rectifier 442 from the first circuit components 302 and the primary energy storage device 202. In some aspects in which the second circuit components 304 include a clock 830 and a scheduler 328, and method 700 may include using the scheduler 328 to count cycles of the clock 830 and periodically set the second control signal from the rectifier power state to the energy storage device power state. In some aspects in which the first circuit components 302 include a controller 320 (e.g., the measurement controller) and application electronics 318 (e.g., measurement electronics), the method 700 may include using the controller 320 to cause the application electronics 318 to perform a sequence (e.g., a measurement sequence).

In some aspects in which the power switch 464 includes the first switch S1, using the power switch 464 to connect the rectifier 442 to the first circuit components 302 (e.g., in step 708 or 710) may include closing the first switch S1, and using the power switch 464 to disconnect the rectifier 442 from the primary energy storage device 202 and the first circuit components 302 (e.g., in step 710) may include opening the first switch S1. In some aspects in which the power switch 464 includes the second switch S2, using the power switch 464 to connect the primary energy storage device 202 to the first circuit components 302 (e.g., in step 710) may include closing the second switch S2, and using the power switch 464 to disconnect the primary energy storage device 202 from the rectifier 442 and the first circuit components 302 (e.g., in step 708 or 710) may include opening the second switch S2.

In some aspects, the process 700 may include using the power switch 464 to connect the primary energy storage device 202 to the first circuit components 302 and disconnect the rectifier 442 from the first circuit components 302 and the primary energy storage device 202 if the first control signal is in the enable energy storage device state (e.g., vbat_cbat_on=1) and a third control signal (e.g., def_sup) is in an energy storage device power state (e.g., def_sup=0). In some aspects, process 700 may include using the power switch 464 to connect the rectifier 442 to the first circuit components 302 and disconnect the primary energy storage device 202 from the first circuit components 302 and the rectifier 442 if the first control signal is in the enable energy storage device state (e.g., vbat_cbat_on=1) and the third control signal is in a rectifier power state (e.g., def_sup=1).

In some aspects in which a first terminal of the primary energy storage device 202 is connected to a first terminal of the secondary energy storage device 469, the process 700 may include, if the power switch 464 is in the energy storage device disabled state, using the power switch 464 to disconnect a second terminal of the primary energy storage device 202 from a second terminal of the secondary energy storage device 469 such that current cannot leak across the secondary energy storage device 469. In some aspects, the process 700 may include, if the power switch 464 is in the energy storage device enabled state, using the power switch 464 to connect the second terminal of the primary energy storage device 202 to the second terminal of the secondary energy storage device 469 such that the secondary energy storage device 469 adds to the power delivery capability of the primary energy storage device 202.

In some aspects in which the power switch 464 includes third switches S3c, S3i, and S3d, using the power switch 464 to connect the primary energy storage device 202 to at least the second circuit components 304 (e.g., in step 710) may include closing the third switches S3c, S3i, and S3d to connect the first terminal of the primary energy storage device 202 to the second circuit components 304 and connect the second terminal of the primary energy storage device 202 to the second terminal of the secondary energy storage device 469. In some aspects, using the power switch 464 to disconnect the primary energy storage device 202 from the second circuit components 304 (e.g., in step 708) may include the third switches S3c, S3i, and S3d to disconnect the first terminal of the primary energy storage device 202 from the second circuit components 304 and disconnect the second terminal of the primary energy storage device 202 from the second terminal of the secondary energy storage device 469.

In some aspects in which the power switch 464 includes the fourth switch S4, using the power switch 464 to disconnect the primary energy storage device 202 from the second circuit components 304 (e.g., in step 708) may include closing the fourth switch S4.

In some aspects, the process 700 may further includes resetting the power switch 464 during a transition from the energy storage device disabled state to the energy storage device enabled state and during a transition from the energy storage device enabled state to the energy storage device disabled. In some aspects, resetting the power switch 464 may occur if a reset control signal (e.g., RFreset) is in a reset state.

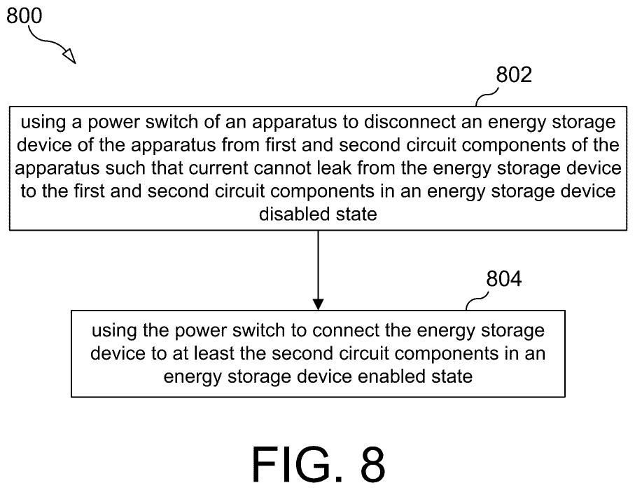

FIG. 8 is a flow chart illustrating a process 800 that may be performed by the system 50 according to some aspects. In some aspects, one or more steps of the method 800 may be performed by an apparatus 100 (e.g., an analyte sensor) of the system 50 (e.g., an analyte monitoring). In some aspects, as shown in FIG. 8, the process 800 may include a step 802 in which the apparatus 100 uses a power switch 464 to disconnect a primary energy storage device 202 of the apparatus 100 from first and second circuit components 302 and 304 of the apparatus 100 such that current cannot leak from the primary energy storage device 202 to the first and second circuit components 302 and 304 in an energy storage device disabled state. In some aspects, the step 800 may include a step 804 in which the apparatus 100 uses the power switch 464 to connect the primary energy storage device 202 to at least the second circuit components 304 in an energy storage device enabled state.

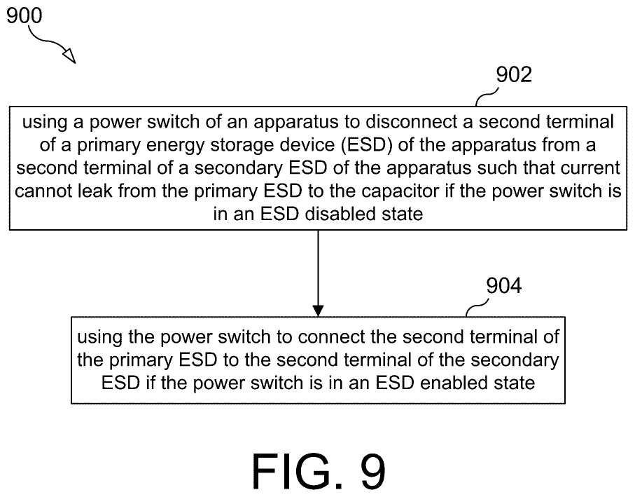

FIG. 9 is a flow chart illustrating a process 900 that may be performed by the system 50 according to some aspects. In some aspects, one or more steps of the method 900 may be performed by an apparatus 100 (e.g., an analyte sensor) of the system 50 (e.g., an analyte monitoring). In some aspects, as shown in FIG. 9, the process 900 may include a step 902 in which the apparatus 100 uses the power switch 464 to disconnect the second terminal of the primary energy storage device 202 from the second terminal of the secondary energy storage device 469 such that current cannot leak across the secondary energy storage device 469 if the power switch 464 is in an energy storage device disabled state. In some aspects, using the power switch 464 to disconnect the second terminal of the primary energy storage device 202 from the second terminal of the secondary energy storage device 469 in step 902 may include opening third switches S3c and S3i of the power switch 464.

In some aspects, as shown in FIG. 9, the process 900 may include a step 904 in which the apparatus 100 uses the power switch 464 to connect the second terminal of the primary energy storage device 202 to the second terminal of the secondary energy storage device 469 such that the secondary energy storage device 469 adds to the power delivery capability of the primary energy storage device 202 if the power switch 464 is in an energy storage device enabled state. In some aspects, using the power switch 464 to connect the second terminal of the primary energy storage device 202 to the second terminal of the secondary energy storage device 469 in step 904 may include closing the third switches S3c and S3i.

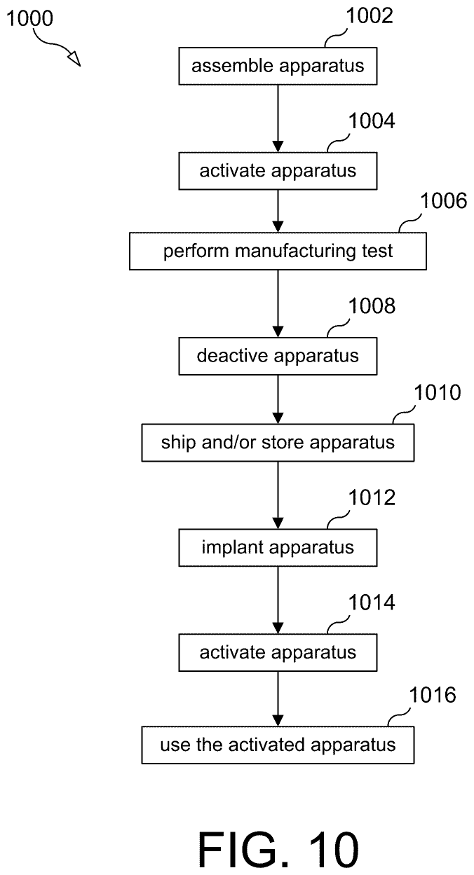

FIG. 10 is a flow chart illustrating a process 1000 of using the apparatus 100 according to some aspects. In some aspects, as shown in FIG. 10, the process 1000 may include a step 1002 of assembling the apparatus 100. In some aspects, the step 1002 may include inserting some or all of the circuitry of the apparatus 100 (e.g., the first circuit components 302, the second circuit components 304, the antenna 114, the rectifier 442, the secondary ESD 469, and/or the power switch 464) into a housing (e.g., housing 102) of the apparatus 100. In some aspects, the step 1002 may include encasing the circuitry within the housing of the apparatus. In some aspects, the primary ESD 202 may also be inserted and encased within the housing. However, this is not required, and, in some alternative aspects, the step 1002 may include attaching the primary ESD 202 to a housing of the apparatus 100 in which circuitry has been encased. In some aspects in which the apparatus 100 is an analyte sensor, the step 1002 may include coating, diffusing, adhering, embedding, or growing analyte and/or interferent indicator material 104 on or in one or more portions of the exterior surface of the housing 102 of the apparatus.

In some aspects, as shown in FIG. 10, the process 1000 may include a step 1004 of activating the apparatus 100. In some aspects, activating the apparatus in step 1004 may include conveying an enable energy storage device command to the apparatus 100. In some aspects, activating the apparatus in step 1004 may include the apparatus 100 receiving the enable energy storage device command. In some aspects, receiving the enable energy storage device command may include the command decoder 322 decoding the enable energy storage device command in data extracted from an alternating current generated by the antenna 114. In some aspects, activating the apparatus in step 1004 may include the command decoder 322 setting the first control signal to enable energy storage device state (e.g., vbat_cbat_on=1) following the command decoder 322 decoding the enable energy storage device command. In some aspects, activating the apparatus in step 1004 may include the power switch 464 entering the energy storage device enabled state following the first control signal being set to the enable energy storage device state (e.g., vbat_cbat_on=1). In some aspects, entering the energy storage device enabled state may include the power switch 464 (i) connecting the primary energy storage device 202 to at least the second circuit components 304 (e.g., by closing third switch S3d and opening the fourth switch S4) and (ii) connecting the second terminal of the primary energy storage device 202 to the second terminal of the secondary energy storage device 469 such that the secondary energy storage device 469 adds to the power delivery capability of the primary energy storage device 202 (e.g., by closing third switches S3c and S3i). In some aspects, entering the energy storage device enabled state may include the power switch 464 closing the third switches S3c, S3d, and S3i and opening the fourth switch S4. In some aspects, entering the energy storage device enabled state in step 1004 may include (1) the power switch 464 connecting the primary energy storage device 202 to at least the second circuit components 304 (e.g., by closing third switch S3d and opening the fourth switch S4) before (2) the power switch 464 connects the second terminal of the primary energy storage device 202 to the second terminal of the secondary energy storage device 469 (e.g., by closing third switches S3c and S3i).

In some aspects, the apparatus 100 may use the first control signal (e.g., vbat_cbat_on) to control (1) whether the power switch 464 connects the primary energy storage device 202 to the second circuit components 304 and (2) whether the power switch 464 connects the second terminal of the primary energy storage device 202 to the second terminal of the secondary energy storage device 469. That is, in some aspects, the power switch 464 may determine whether to close or open the third switches S3c, S3d, and S3i and the fourth switch S4 based on the first control signal (e.g., vbat_cbat_on). However, this is not required, and, in some alternative aspects, the apparatus 100 may use (1) one control signal to control whether the power switch 464 connects the primary energy storage device 202 to the second circuit components 304 and (2) a different control signal to control whether the power switch 464 connects the second terminal of the primary energy storage device 202 to the second terminal of the secondary energy storage device 469. In some of these alternative aspects, activating the apparatus in step 1004 may include conveying two commands to the apparatus 100: (1) a first command that causes the apparatus 100 to set one control signal to cause the power switch 464 to connect the primary energy storage device 202 to at least the second circuit components 304 (e.g., by closing third switch S3d and opening the fourth switch S4) and (2) a second command that causes the apparatus 100 to set a different control signal to cause the power switch 464 to connect the second terminal of the primary energy storage device 202 to the second terminal of the secondary energy storage device 469 such that the secondary energy storage device 469 adds to the power delivery capability of the primary energy storage device 202 (e.g., by closing third switches S3c and S3i). In some of these alternative aspects, the second command may be conveyed after the first command.

In some aspects, as shown in FIG. 10, the process 1000 may include a step 1006 of performing a manufacturing test of the apparatus 100. In some aspects, performing a manufacturing test may include testing whether the scheduler 328 of the second circuit components 304 is capable of counting cycles of the clock 830 and periodically setting the second control signal from the rectifier power state (e.g., vbat_to_vsup=0) to the energy storage device power state (e.g., vbat_to_vsup=1), testing whether setting the second control signal from the rectifier power state to the energy storage device power state causes the power switch 464 to connect the primary energy storage device 202 to the first circuit components 302 and disconnect the rectifier 442 from the first circuit components 302 and the primary energy storage device 202, and/or testing whether connecting the primary energy storage device 202 to the first circuit components 302 causes the controller 320 of the first circuit components 302 to control the application electronics 318 of the first circuit components 302 to perform a sequence (e.g., a measurement controller may be configured to cause the measurement electronics to perform a measurement sequence in some aspects in which the apparatus 100 is a sensor, a pacemaker controller may be configured to cause the pacemaking electronics to perform a pacemaking sequence in some aspects in which the apparatus 100 is a pacemaker, or an electrical/heat therapy controller may cause electrical/heat therapy electronics to perform an electrical/heat therapy sequence in some aspects in which the apparatus 100 is an electrical/heat therapy device).

In some aspects, as shown in FIG. 10, the process 1000 may include a step 1008 of deactivating the apparatus 100. In some aspects, deactivating the apparatus in step 1008 may include conveying a disable energy storage device command to the apparatus 100. In some aspects, deactivating the apparatus in step 1008 may include the apparatus 100 receiving the disable energy storage device command. In some aspects, receiving the disable energy storage device command may include the command decoder 322 decoding the disable energy storage device command in data extracted from an alternating current generated by the antenna 114. In some aspects, deactivating the apparatus in step 1008 may include, following the command decoder 322 decoding the disable energy storage device command, the command decoder 322 setting the first control signal to the disable energy storage device state (e.g., vbat_cbat_on=0) and/or setting the second control signal to the rectifier power state (e.g., vbat_to_vsup=0). In some aspects, deactivating the apparatus in step 1008 may include the power switch 464 entering the energy storage device disabled state following the first control signal being set to the disable energy storage device state (e.g., vbat_cbat_on=0) and the second control signal being set to the rectifier power state (e.g., vbat_to_vsup=0). In some aspects, entering the energy storage device disabled state may include the power switch 464 (i) disconnecting the second terminal of the primary energy storage device 202 from the second terminal of the secondary energy storage device 469 (e.g., by opening third switches S3c and S3i), (ii) disconnecting the primary energy storage device 202 from the second circuit components 304 (e.g., by opening third switch S3d and closing the fourth switch S4), and/or (iii) disconnecting the primary energy storage device 202 from the first circuit components 302 (e.g., by opening the second switch S2). In some aspects, entering the energy storage device disabled state may also include the power switch 464 connecting the rectifier 442 to the first circuit components 302 (e.g., by closing the first switch S1). In some aspects, entering the energy storage device disabled state may include the power switch 464 closing the first switch S1, opening the second switch S2, opening the third switches S3c, S3d, and S3i, and closing the fourth switch S4.

In some aspects, as shown in FIG. 10, the process 1000 may include a step 1010 of shipping and/or storing the deactivated apparatus 100. In some aspects, the apparatus 100 may be shipped and/or stored in step 1010 with the power switch 464 in the energy storage device disabled state in which (i) the primary energy storage device 202 is disconnected from the first and second circuit components 302 and 304 and/or (ii) the second terminal of the primary energy storage device 202 is disconnected from the second terminal of the secondary energy storage device 469. In some aspects, with the power switch 464 in the energy storage device disabled state, current cannot leak from the primary energy storage device 202 to the first and second circuit components 302 and 304, and/or current cannot leak across the secondary energy storage device 469.

In some aspects, as shown in FIG. 10, the process 1000 may include a step 1012 of implanting the apparatus 100 (e.g., via subcutaneous implantation or intraperitoneal implantation). In some aspects, the step 1012 may include fully implanting the apparatus 100 or partially implanting the apparatus 100.

In some aspects, as shown in FIG. 10, the process 1000 may include a step 1014 of activating the implanted apparatus 100. In some aspects, activating the apparatus in step 1004 may include conveying an enable energy storage device command to the apparatus 100. In some aspects, the transceiver 101 or display device 105 may convey the enable energy storage device command to the apparatus 100 in step 1014. In some aspects, activating the apparatus in step 1014 may include the apparatus 100 receiving the enable energy storage device command. In some aspects, receiving the enable energy storage device command may include the command decoder 322 decoding the enable energy storage device command in data extracted from an alternating current generated by the antenna 114. In some aspects, activating the apparatus in step 1014 may include the command decoder 322 setting the first control signal to enable energy storage device state (e.g., vbat_cbat_on=1) following the command decoder 322 decoding the enable energy storage device command. In some aspects, activating the apparatus in step 1014 may include the power switch 464 entering the energy storage device enabled state following the first control signal being set to the enable energy storage device state (e.g., vbat_cbat_on=1). In some aspects, entering the energy storage device enabled state may include the power switch 464 (i) connecting the primary energy storage device 202 to at least the second circuit components 304 (e.g., by closing third switch S3d and opening the fourth switch S4) and (ii) connecting the second terminal of the primary energy storage device 202 to the second terminal of the secondary energy storage device 469 such that the secondary energy storage device 469 adds to the power delivery capability of the primary energy storage device 202 (e.g., by closing third switches S3c and S3i). In some aspects, entering the energy storage device enabled state may include the power switch 464 closing the third switches S3c, S3d, and S3i and opening the fourth switch S4.

In some aspects, the apparatus 100 may use the first control signal (e.g., vbat_cbat_on) to control (1) whether the power switch 464 connects the primary energy storage device 202 to the second circuit components 304 and (2) whether the power switch 464 connects the second terminal of the primary energy storage device 202 to the second terminal of the secondary energy storage device 469. That is, in some aspects, the power switch 464 may determine whether to close or open the third switches S3c, S3d, and S3i and the fourth switch S4 based on the first control signal (e.g., vbat_cbat_on). However, this is not required, and, in some alternative aspects, the apparatus 100 may use (1) one control signal to control whether the power switch 464 connects the primary energy storage device 202 to the second circuit components 304 and (2) a different control signal to control whether the power switch 464 connects the second terminal of the primary energy storage device 202 to the second terminal of the secondary energy storage device 469. In some of these alternative aspects, activating the apparatus in step 1014 may include conveying two commands to the apparatus 100: (1) a first command that causes the apparatus 100 to set one control signal to cause the power switch 464 to connect the primary energy storage device 202 to at least the second circuit components 304 (e.g., by closing third switch S3d and opening the fourth switch S4) and (2) a second command that causes the apparatus 100 to set a different control signal to cause the power switch 464 to connect the second terminal of the primary energy storage device 202 to the second terminal of the secondary energy storage device 469 such that the secondary energy storage device 469 adds to the power delivery capability of the primary energy storage device 202 (e.g., by closing third switches S3c and S3i). In some of these alternative aspects, the second command may be conveyed after the first command.

In some aspects, as shown in FIG. 10, the process 1000 may include a step 1016 of using the activated apparatus 100. In some aspects, using the activated apparatus 100 in step 1016 may include the scheduler 328 of the second circuit components 304 counting cycles of the clock 830 and periodically setting the second control signal from the rectifier power state (e.g., vbat_to_vsup=0) to the energy storage device power state (e.g., vbat_to_vsup=1), which may cause the power switch 464 to connect the primary energy storage device 202 to the first circuit components 302 (and disconnect the rectifier 442 from the first circuit components 302 and the primary energy storage device 202). In some aspects, using the activated apparatus 100 in step 1016 may include the controller 320 of the first circuit components 302 controlling the application electronics 318 of the first circuit components 302 to perform a sequence (e.g., a measurement controller causing measurement electronics to perform a measurement sequence, a pacemaker controller causing pacemaking electronics to perform a pacemaking sequence, or an electrical/heat therapy controller causing electrical/heat therapy electronics to perform an electrical/heat therapy sequence).

Aspects of the present invention have been fully described above with reference to the drawing figures. Although the invention has been described based upon these preferred aspects, it would be apparent to those of skill in the art that certain modifications, variations, and alternative constructions could be made to the described aspects within the spirit and scope of the invention. For example, although FIGS. 2A-2C show the apparatus 100 as including both a primary energy storage device 202 and a secondary energy storage device 469, this is not required, and, in some alternative aspects, the apparatus 100 may include an energy storage device 202 and not include a secondary energy storage device 469.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel. For example, although FIG. 7 shows the step 710 of using the power switch 464 to connect the primary energy storage device 202 to at least the second circuit components 304 in an energy storage device enabled state as occurring after the step 708, this is not required, and in some alternative aspects, step 710 may be performed before step 708. Similarly, although FIG. 8 shows the step 804 of using the power switch 464 to connect the primary energy storage device 202 to at least the second circuit components 304 in an energy storage device enabled state as occurring after the step 802, this is not required, and, in some alternative aspects, the step 804 may be performed before the step 802. Similarly, although FIG. 9 shows the step 904 occurring after the step 902, this is not required, and, in some alternative aspects, the step 904 may be performed before the step 902. Similarly, although FIG. 10 shows the step 1014 occurring after the step 1012, this is not required, and, in some alternative aspects, the step 1014 may be performed before the step 1012.

What is claimed is:

1. An apparatus comprising:
an energy storage device;
first circuit components;
second circuit components;
an antenna configured to generate an alternating current when in an electromagnetic field;
a rectifier configured to convert the alternating current to direct current; and
a power switch configured to:
disconnect the energy storage device from the first and second circuit components such that current cannot leak from the energy storage device to the first and second circuit components and connect the rectifier to the first circuit components in an energy storage device disabled state; and
connect the energy storage device to at least the second circuit components in an energy storage device enabled state.

2. The apparatus of claim 1, wherein the second circuit components comprise a clock and a scheduler.

3. The apparatus of claim 1, wherein the power switch is configured to enter the energy storage device disabled state if a first control signal is in a disable energy storage device state and a second control signal is in a rectifier power state, and the power switch is configured to enter the energy storage device enabled state if the first control signal is in an enable energy storage device state.

4. The apparatus of claim 3, wherein the power switch is further configured to:
connect the energy storage device to the first circuit components and disconnect the rectifier from the first circuit components and the energy storage device if the first control signal is in the enable energy storage device state and the second control signal is in an enable storage device power state; and
connect the rectifier to the first circuit components and disconnect the energy storage device from the first circuit components and the rectifier if the first control signal is in the enable energy storage device state and the second control signal is in the rectifier power state.

5. The apparatus of claim 4, wherein the second circuit components comprise a clock and a scheduler configured to count cycles of the clock and periodically set the second control signal from the rectifier power state to the energy storage device power state.

6. The apparatus of claim 5, wherein the first circuit components include a measurement controller and measurement electronics, and the measurement controller is configured to cause the measurement electronics to perform a measurement sequence.

7. The apparatus of claim 3, wherein the first circuit components comprise a command decoder configured to decode commands in data extracted from the alternating current generated by the antenna.

8. The apparatus of claim 7, wherein the command decoder is configured to set the first control signal to the disable energy storage device state if the command decoder decodes a disable energy storage device command and to set the first control signal to the enable energy storage device state if the command decoder decodes an enable energy storage device command.

9. The apparatus of claim 3, wherein the power switch is further configured to:
connect the energy storage device to the first circuit components and disconnect the rectifier from the first circuit components and the energy storage device if the first control signal is in the enable energy storage device state and a third control signal is in an energy storage device power state; and
connect the rectifier to the first circuit components and disconnect the energy storage device from the first circuit components and the rectifier if the first control signal is in the enable energy storage device state and the third control signal is in a rectifier power state.

10. The apparatus of claim 1, wherein the power switch comprises a first switch, and the power switch is configured to connect the rectifier to the first circuit components when the first switch is closed and disconnect the rectifier from the energy storage device and the first circuit components when the first switch is open.

11. The apparatus of claim 1, wherein the power switch comprises a second switch, and the power switch is configured to connect the energy storage device to the first circuit components when the second switch is closed and disconnect the energy storage device from the rectifier and the first circuit components when the second switch is open.

12. The apparatus of claim 1, wherein the energy storage device is a primary energy storage device, the apparatus further comprises a secondary energy storage device, the primary energy storage device has greater energy storage capacity than the secondary energy storage device, the secondary energy storage device has greater power delivery than the primary energy storage device, a first terminal of the primary energy storage device is connected to a first terminal of the secondary energy storage device, and the power switch is further configured to:
disconnect a second terminal of the primary energy storage device from a second terminal of the secondary energy storage device such that current cannot leak across the secondary energy storage device if the power switch is in the energy storage device disabled state; and
connect the second terminal of the primary energy storage device to the second terminal of the secondary energy storage device such that the secondary energy storage device adds to the power delivery capability of the primary energy storage device if the power switch is in the energy storage device enabled state.

13. The apparatus of claim 12, wherein the power switch comprises third switches, and the power switch is configured to connect the first terminal of the primary energy storage device to the second circuit components and connect the second terminal of the primary energy storage device to the second terminal of the secondary energy storage device by closing the third switches and disconnect the first terminal of the primary energy storage device from the second circuit components and disconnect the second terminal of the primary energy storage device from the second terminal of the secondary energy storage device by opening the third switches.

14. The apparatus of claim 1, wherein the power switch comprises a fourth switch, and the power switch is configured to prevent the energy storage device from supplying power to the second circuit components when the fourth switch is closed.

15. The apparatus of claim 1, wherein the power switch is further configured to be reset during a transition from the energy storage device disabled state to the energy storage device enabled state and during a transition from the energy storage device enabled state to the energy storage device disabled.

16. A method comprising:
using an antenna of an apparatus to generate an alternating current when in an electromagnetic field;
using a rectifier of the apparatus to convert the alternating current to direct current;
using a power switch of the apparatus to disconnect an energy storage device of the apparatus from first and second circuit components of the apparatus such that current cannot leak from the energy storage device to the first and second circuit components and connect the rectifier to the first circuit components in an energy storage device disabled state; and
using the power switch to connect the energy storage device to at least the second circuit components in an energy storage device enabled state.

17. The method of claim 16, wherein the second circuit components comprise a clock and a scheduler.

18. The method of claim 16, further comprising:
entering the energy storage device disabled state if a first control signal is in a disable energy storage device state and a second control signal is in a rectifier power state, and
entering the energy storage device enabled state if the first control signal is in an enable energy storage device state.

19. The method of claim 18, further comprising:
using the power switch to connect the energy storage device to the first circuit components and disconnect the rectifier from the first circuit components and the energy storage device if the first control signal is in the enable energy storage device state and the second control signal is in an energy storage device power state; and
using the power switch to connect the rectifier to the first circuit components and disconnect the energy storage device from the first circuit components and the rectifier if the first control signal is in the enable energy storage device state and the second control signal is in the rectifier power state.

20. The method of claim 19, wherein the second circuit components comprise a clock and a scheduler, and the method further comprises using the scheduler to count cycles of the clock and periodically set the second control signal from the rectifier power state to the energy storage device power state.

21. The method of claim 20, wherein the first circuit components include a measurement controller and measurement electronics, and the method further comprises using the measurement controller to cause the measurement electronics to perform a measurement sequence.

22. The method of claim 19, wherein the power switch comprises a first switch, using the power switch to connect the rectifier to the first circuit components comprises closing the first switch, and using the power switch to disconnect the rectifier from the energy storage device and the first circuit components comprises opening the first switch.

23. The method of claim 19, wherein the power switch comprises a second switch, using the power switch to connect the energy storage device to the first circuit components comprises closing the second switch, and using the power switch to disconnect the energy storage device from the rectifier and the first circuit components comprises opening the second switch.

24. The method of claim 19, wherein the first circuit components comprise a command decoder, and the method further comprises using the command decoder to decode commands in data extracted from the alternating current generated by the antenna.

25. The method of claim 24, wherein the command decoder configured to set the first control signal to the disable energy storage device state if the command decoder decodes a disable energy storage device command and to set the first control signal to the enable energy storage device state if the command decoder decodes an enable energy storage device command.

26. The method of claim 18, further comprising:
using the power switch to connect the energy storage device to the first circuit components and disconnect the rectifier from the first circuit components and the energy storage device if the first control signal is in the enable energy storage device state and a third control signal is in an energy storage device power state; and
using the power switch to connect the rectifier to the first circuit components and disconnect the energy storage device from the first circuit components and the rectifier if the first control signal is in the enable energy storage device state and the third control signal is in a rectifier power state.

27. The method of claim 16, wherein the energy storage device is a primary energy storage device, a first terminal of the primary energy storage device is connected to a first terminal of a secondary energy storage device of the apparatus, the primary energy storage device has greater energy storage capacity than the secondary energy storage device, the secondary energy storage device has greater power delivery than the primary energy storage device, and the method further comprises:
using the power switch to disconnect a second terminal of the primary energy storage device from a second terminal of the secondary energy storage device such that current cannot leak across the secondary energy storage device if the power switch is in the energy storage device disabled state; and
using the power switch to connect the second terminal of the primary energy storage device to the second terminal of the secondary energy storage device such that the secondary energy storage device adds to the power delivery capability of the primary energy storage device if the power switch is in the energy storage device enabled state.

28. The method of claim 27, wherein the power switch comprises third switches, using the power switch to connect the primary energy storage device to at least the second circuit components comprises closing the third switches to connect the first terminal of the primary energy storage device to the second circuit components and connect the second terminal of the primary energy storage device to the second terminal of the secondary energy storage device, and using the power switch to disconnect the primary energy storage device from the second circuit components comprises opening the third switches to disconnect the first terminal of the primary energy storage device from the second circuit components and disconnect the second terminal of the primary energy storage device from the second terminal of the secondary energy storage device.

29. The method of claim 26, wherein the power switch comprises a fourth switch, and using the power switch to disconnect the energy storage device from the second circuit components comprises closing the fourth switch.

30. The method of claim 26, further comprising resetting the power switch during a transition from the energy storage device disabled state to the energy storage device enabled state and during a transition from the energy storage device enabled state to the energy storage device disabled.

31. An apparatus comprising:
an energy storage device;
first circuit components;
second circuit components; and
a power switch configured to:
disconnect the energy storage device from the first and second circuit components such that current cannot leak from the energy storage device to the first and second circuit components in an energy storage device disabled state; and
connect the energy storage device to at least the second circuit components in an energy storage device enabled state.

32. The apparatus of claim 31, wherein the power switch is configured to enter the energy storage device disabled state if a first control signal is in a disable energy storage device state and a second control signal is not in an energy storage device power state, and the power switch is configured to enter the energy storage device enabled state if the first control signal is in an enable energy storage device state.

33. A method comprising:
using a power switch of an apparatus to disconnect an energy storage device of the apparatus from first and second circuit components of the apparatus such that current cannot leak from the energy storage device to the first and second circuit components in an energy storage device disabled state; and
using the power switch to connect the energy storage device to at least the second circuit components in an energy storage device enabled state.

34. An apparatus comprising:
a primary energy storage device;
a secondary energy storage device, wherein a first terminal of the energy storage device is connected to a first terminal of the capacitor, the primary energy storage device has greater energy storage capacity than the secondary energy storage device, and the secondary energy storage device has greater power delivery than the primary energy storage device; and
a power switch configured to:
disconnect a second terminal of the primary energy storage device from a second terminal of the secondary energy storage device such that current cannot leak across the secondary energy storage device if the power switch is in an energy storage device disabled state; and
connect the second terminal of the primary energy storage device to the second terminal of the secondary energy storage device such that the secondary energy storage device adds to the power delivery capability of the primary energy storage device if the power switch is in an energy storage device enabled state.

35. The apparatus of claim 34, wherein the power switch comprises third switches, and the power switch is configured to connect the second terminal of the primary energy storage device to the second terminal of the secondary energy storage by closing the third switches and disconnect the second terminal of the primary energy storage device from the second terminal of the capacitor by opening the third switches.

36. A method comprising:
using a power switch of an apparatus to disconnect a second terminal of a primary energy storage device of the apparatus from a second terminal of a secondary energy storage device of the apparatus such that current cannot leak across the secondary energy storage device if the power switch is in an energy storage device disabled state, wherein the primary energy storage device has greater energy storage capacity than the secondary energy storage device, the secondary energy storage device has greater power delivery than the primary energy storage device, and a first terminal of the primary energy storage device is connected to a first terminal of the secondary energy storage device; and
using the power switch to connect the second terminal of the primary energy storage device to the second terminal of the secondary energy storage device such that the secondary energy storage device adds to the power delivery capability of the primary energy storage device if the power switch is in an energy storage device enabled state.

37. The method of claim 36, wherein using the power switch to disconnect the second terminal of the primary energy storage device from the second terminal of the secondary energy storage device comprises opening third switches of the power switch, and using the power switch to connect the second terminal of the primary energy storage device to the second terminal of the secondary energy storage device comprises closing the third switches.
